(19) United States
(12) Patent Application Publication
(10) Pub. No.: US 2025/0135625 A1
(43) Pub. Date: May 1, 2025

(54) ERGONOMIC HOLDERS FOR HAND TOOLS

(71) Applicant: FreeForm Brush, Inc., Las Vegas, NV (US)

(72) Inventor: Gregory Brian Freuler, Las Vegas, NV (US)

(21) Appl. No.: 18/832,551

(22) PCT Filed: Jan. 26, 2023
(86) PCT No.: PCT/US2023/011647

§ 371 Date: Jul. 24, 2024

Related U.S. Application Data
(60) Provisional application No. 63/303,768, filed on Jan. 27, 2022.

(51) Int. Cl. B25G 1/10; A46B 5/00; A46B 5/02; A46B 17/02; B25G 1/04

(52) U.S. Cl. CPC B25G 1/102; A46B 5/002; A46B 5/0095; A46B 5/021; A46B 17/02; A46B 2200/202; B25G 1/04

(57) ABSTRACT

Ergonomic handles and cartridge systems that support a hand-tool working end or a whole tool (such as a paintbrush) while being received comfortably in the user's hand when it is in its natural resting angle with respect to the wrist. The holder is configured to operationally engage with a cartridge of one more parts that supports or is configured to receive and support a tool.

### CROSS-REFERENCE TO RELATED APPLICATIONS

This application is a national stage of PCT Application No. PCT/US2023/011647, having a filing date of Jan. 26, 2023, which claims priority to U.S. Provisional Application 63/303,768, having a filing date of Jan. 27, 2022, the entire contents both of which are hereby incorporated by reference.

### FIELD OF TECHNOLOGY

This disclosure generally relates to hand tools and, particularly, to ergonomic holders for hand tools. More particularly, it is related to ergonomic handles and cartridge systems that support a hand-tool working end or a whole tool (such as a paintbrush) while being received comfortably in the user's hand when it is in its natural resting angle with respect to the wrist. The holder is configured to operationally engage with a cartridge of one or more parts that supports or is configured to receive and support a tool.

### BACKGROUND

Hand tools of a seemingly infinite variety have been developed for many purposes, and are currently used by individuals ranging in skill level from craftsmen with many years of trade experience to untrained persons needing to accomplish a simple task around the house. One thing many hand tools have in common, however, is that prolonged use and repeated manipulation of a hand tool, such as a screwdriver, a ratchet, a paintbrush, and so forth, tends to cause user fatigue. This is commonly because the same muscles and joints that are used to manipulate the hand tool, generally those of the user's fingers and/or wrist, also bear the weight of the hand tool. Use of a paintbrush, for example, generally involves not only supporting a wet brush made heavy with paint, but also requires repetitive back-and-forth movement of the user's wrist and\or force applied with the fingers. Also, the orientation at which the tool must be held when used, such as a paint brush when applying paint to a surface, often requires the user's hand to be at an angle with respect to the user's wrist, further contributing to user discomfort.

Moreover, a hand tool such as a paintbrush, often needs to change its angle of rotation relative to the orientation of the working surface, requiring the tool to be flipped, or rotated. This rotational manipulation of the tool may be challenging, or impossible to achieve, if the tool was not designed to be rotated. Holding a tool in a manner for which it is not designed can additionally contribute to stress in the user's fingers, wrist, hand, arm, and shoulder. Also, when using a tool such as a paintbrush, the user may be standing on a ladder, scaffolding, or other elevated positions, where use of three-points-of-contact may be needed for stability and safety. In these situations, the rotation of the tool must be done with one hand to ensure safety.

Many hand tools come in different shapes, sizes, and types, for different applications. A paint brush, for example, comes in different sizes. shapes, angled and flat-end filaments, and filament types. Ergonomic handle designs can often be expensive to produce. A user needing multiple shapes, sizes, or types of tools, might be forced to buy multiple ergonomic tool assemblies at a great cost. Shaving razor manufacturers have long since discovered the benefits of allowing separation of the razor from the handle by use of either individual razors, or razor cartridges which attach to the handle. This allows the user to purchase a relatively expensive, ergonomic handle only once, while in the future needing to purchase only razors, or razor cartridges. This not only reduces the raw materials consumed, it reduces the cost of production and subsequent retail price to the user, it also reduces the shipping size, weight and cost, and associated fuel used to transport the goods, and ultimately reducing the waste material in our landfills and environment. This has benefits to all parties.

In view of the foregoing disadvantages and deficits in the prior art, there is a substantial need for solutions to the foregoing issues.

### SUMMARY

The inventive subject matter disclosed herein addresses the foregoing issues and more. Illustrative embodiments of ergonomic holders or handles for hand tools are disclosed, along with various examples of hand tools usable with the holders. Although the handle of the inventive subject matter is adaptable to many tool-head configurations, we will focus largely on painting tools in our description, as a representative example. The inventive subject matter is also directed to cartridge assemblies that removably connect to the holders and support hand tools. A paintbrush cartridge, or any other adapted tool-head in replacement of a brush-head for painting are disclosed herein as representative, but non-limiting, cartridge assemblies. An assembly of the holder and the cartridge assembly are also considered inventive subject matter. (Generally, unless context indicates otherwise, the terms “holder” and “handle” are used interchangeably herein.”)

In general, the ergonomic handle and cartridge system disclosed herein support a tool end or a tool (such as a paintbrush), or a portion thereof, for use, while being received comfortably in the user's hand when it is in its natural resting angle with respect to the wrist. To this end, the holders define hand rest areas adapted to engage and rest against the “saddle” of a user's hand (that is, the region of the hand between the user's thumb and forefinger, and the area surrounding this region on the front and back of the user's hand), when the handle is held. Accordingly, when the handle is held with the tool in position use, the weight of the holder and its supported load is distributed to the dorsal saddle area of the user's hand and/or the metacarpal region of the back of the user's hand, allowing the user's arm to bear the weight, while the user's wrist and finger guide, rather than carry, the tool. When referring herein to a “handle” we are referring to the inventive subject matter as a general embodiment, not specifically to any particular handle embodiment. When referring to a “complete brush” of the inventive subject matter described herein, unless specified as a complete 2-part brush, or as a complete 3-part brush, it is referring to a combination that includes a handle and cartridge, or brush-head cartridge, for painting. When referring to a “cartridge” or “brush head cartridge” of the subject matter, in general terms, without reference to a 1-part brush-head cartridge (of a 2-part brush), or 2-part brush-head cartridge (of a 3-part brush), the terms may describe any embodiment making up a “cartridge” or “brush-head cartridge” of the inventive subject matter. In such embodiments, the assembly includes a handle, a cartridge, and a tool head, or an extension plus a tool head. The handle having a downwardly, vertically extending proximal handle portion for receiving the palmer saddle of an intended user's hand and extending therefrom a horizontally extending distal handle portion for receiving a cartridge.

In one possible embodiment, the inventive subject matter is directed to a handle having a face with a recess for receiving a shaft of a cartridge, the shaft and recess being alignable along the longitudinal axis of the distal handle, the recess being configured so that the shaft is rotatable in the recess, the face having one or more engagement elements that engage with complementary engagement elements on an opposing surface of the cartridge so the cartridge may be rotated around the axis at least 90 degrees from a first position to a second position, the complementary engagement elements lockably engaging in plurality of positions to fix the position of the cartridge relative to the handle. In any embodiment disclosed herein, the handle may be configured so that when the intended user is gripping the handle with the palmar saddle against the palm rest area, the face of the handle is proximal to the user's first knuckle, which is known as the proximal interphalangeal joint. The handle may have one or more contoured areas including on opposing lateral sides of the body, a pair of upper and lower ridges flaring from the body and extending longitudinally along each of the opposing sides of the body. Each pair of ridges are configured to (1) abuttingly engage the respective forefinger or thumb placed in the rest area during use, and/or (2) a hand rest area having a bottom-facing surface disposed on the body above the thumb and forefinger rest areas and above the handgrip. The bottom-facing surface extends longitudinally, rearwardly from the body beyond the forefinger and thumb rest areas, the bottom surface extending laterally wider than the body so as to be configured to cover the dorsal saddle area of the intended user.

In any embodiment, a handle according to the inventive subject matter may include finger and thumb rest areas that are respectively configured with outwardly facing concave in which the bottom facing surface of the hand rest area is concave along its longitudinal axis of the body. In any embodiment, a handle according to the inventive subject matter may include a lower ridge having a portion distally offset from the upper ridge, a longitudinal finger and thumb rest area divided into two parts: (1) a rearward handle and a (2) forward cartridge, the handle's forward facing surface ending at a juncture slightly rearward of the first knuckle of the forefinger of the user when an intended user is properly holding the handle, i.e., holding it in a normal intended manner. In any embodiment, a handle according to the inventive subject matter may have a rearward handle with a forward cartridge having mirrored surface edges, which are mirrored both vertically and horizontally by planes crossing at the center of the handle receiver channel and cartridge shaft, allowing a blended curve-continuous surface at the juncture, and extending the longitudinal finger and thumb rest areas to continue from the rearward handle to the forward cartridge. A pair of upper and lower ridges may flare from the body and extend longitudinally along each of the opposing sides of the body, with each pair of ridges defining respective finger and thumb rest areas, each pair of ridges configured to abuttingly engage the respective fingers or some placed in the rest area during use. The surface of the cartridge between the outermost regions of the upper and lower finger and thumb rest areas, from the juncture of the handle and cartridge and forward of the cartridge, may have tangency distally from its rearward-facing face, the surface of the handle having tangency approximately from its forward-facing face, the handle and cartridge surfaces having a curve continuous surface through the finger and thumb rest areas.

In any embodiment, a handle according to the inventive subject matter may have two halves which are mirrored allowing for right hand or left-hand use.

In any embodiment, a handle according to the inventive subject matter may be configured such that by placing the weight in the dorsal saddle of the hand it allows the user's fingers to be free from holding the weight of the handle and allows the fingers to rotate the cartridge freely 360 degrees. In any embodiment, a handle according to the inventive subject matter may be configured with a juncture of the face of the handle and face of the cartridge being at a point proximal to the first joint of the user's forefinger when the user is properly holding the handle, allowing the user to rotate the cartridge using the fingers of the hand holding the handle. When so gripped, the cartridge rotation may generally be initiated with the user's middle finger by bending the middle finger laterally from its first knuckle while contacting the surface of the lower finger and thumb rest area of the cartridge and continuing to bend the middle finger across the lower portion of the face of the handle until the palmar surface of the middle finger is abuttingly coming to rest on the handle face. In so doing, the natural position of the user's middle finger from that action is placed abuttingly against the two mirrored outward-most surface regions of the finger and thumb rest areas of that side of the cartridge. This creates a natural stop or support position for the cartridge, preventing the cartridge from inadvertent and unwanted rotation. The rotation may continue by the forefinger moving on top of the horizontally oriented cartridge and pulling downward. This may be done by both right-handed and left-handed users.

In any embodiment, a handle according to the inventive subject matter may such that the angle of the palmar saddle area of the handle relative to the angle of the finger rest areas allows the user to maintain a neutral wrist and hand position regardless of the orientation of the toolhead, or in painting the brush head regardless of the direction of the painting stroke.

In any embodiment, a handle according to the inventive subject matter may be over-molded and/or textured to provide greater comfort and stability to the user.

In any embodiment, a handle according to the inventive subject matter may be divided into parts, or regions, including a separate top, face, bottom plug, and two halves. The separate face may be produced in different lengths to accommodate users of all hand sizes.

In any embodiment, a handle according to the inventive subject matter may be configured such that the shape of the handle rearward of its forward face may have multiple shapes to serve multiple different functions.

In any embodiment, a handle according to the inventive subject matter may include an integrated lock mechanism, which locks the cartridge in its given position at specified intervals. In any embodiment, the lock feature may be assembled by mating the top and bottom halves of the mechanism. The lower body may be placed below the lock feature opening on the distal front of the handle top and lowering the push button through the handle top opening into a recessed area on top of the lock body and snapping the two mirrored male snaps of the push button into the corresponding recesses on the body. The lock mechanism may be configured with a cantilevered push button based lock assembly. The lock assembly may include: a top push button, a main body including, a distally longitudinal shaft, two mirrored slide rails, and two mirrored lock stop posts. At rest, in its disengage position, the two stop lock posts lay rearward of the two mirrored lock mechanism position stops, which are located on the underside of the handle top. To engage the lock, the push button is depressed and pushed forward to its distal most position, passing through the lock pass-through on the face of the handle and into one of the extension cartridge face lock post pass-throughs. With the lock stop post of the lock mechanism having traveled past the lock mechanism position stop, the button is released, securing it in the cartridge. To disengage the lock, the procedure is reversed.

In any embodiment, a handle according to the inventive subject matter may have separate lower proximal and upper distal sections, which are at least partially separated from each other by an intermediate section having a greater degree of flexibility than the proximal section. These sections may be connected by a strut that is bendable within a vertical plane of the handle, which can adjust the distance of the angle between the hand rest area and the lower palmar saddle rest area, to accommodate different hand sizes, with the upper and lower regions being over-molded with a soft elastomer material, and/or textured, providing greater comfort and stability to the user. In any embodiment, a handle according to the inventive subject matter may include an accessory port, which can receive strap features, counterweights, LED lights, LED-integrated counterweights, a clock or smart watch attachment, and/or so on. The handle accessory port may be located near the proximal end of the handle top and may be configured with a twist-turn keylock mechanism. Opposing mating alignment stop features on the handle accessory port and accessory may securing the given accessory in position. The accessory may be lowered through an opening in the accessory port at a 90-degree angle to its final orientation. It then may be turned 90 degrees clockwise where the leading edge of the key lock feature of the accessory abuttingly connects to a wall within the accessory port. Complementary opposing mating features of the accessory and accessory port further may then secure the accessory in its position.

As used herein, the term “cartridge” describes an independent extension to a handle with a shaft and complementary engaging elements for the opposing handle. In one possible embodiment according to the inventive subject matter, the handle is configured for use with an independent, complementary cartridge for supporting a tool. One example of a suitable handle for use with a cartridge may include a downwardly, vertically extending proximal handle portion for receiving the palmar saddle of an intended user's hand and, extending therefrom, a horizontally extending distal handle portion for receiving a cartridge.

The distal handle portion has a face for operationally engaging with a cartridge. For example, the face may include a recess configured for receiving a shaft of a cartridge. The shaft and recess may be alignable along the longitudinal axis of the distal handle, and the recess being configured so that the shaft is rotatable in the recess. The face may have one or more engagement elements that engage with complementary engagement elements on an opposing surface of the cartridge so that the cartridge may be rotated around the axis at any desired degree. For many applications, the rotation will be at least 90 degrees from a first position to a second position, and multiple positions may be selected from in such an increment or any other selected increment between 0-360 degrees. The complementary engagement elements may be lockably engageable in a plurality of positions to fix the position of the cartridge relative to the handle. There may also be infinitely adjustable positions which can be locked into. Persons skilled in the art will appreciate how two items may be rotated and locked relative to one another using known mechanisms.

A roller for applying paint is one of many hand tools that can be removably or fixedly disposed at the end of a cartridge. A roller insert may be constructed of a hard plastic material. It is inserted proximally into the distal face of the extension cartridge, with its rearward-facing alignment shaft mating to the transition shaft receiver within the transition receiver channel of the extension cartridge. The roller may have insertable alignment ribs that mate to the interior wall of the extension cartridge transition receiver channel. The roller insert may have a spherical deboss, which mates to a spherical embossed feature on the interior wall of the transition receiver channel, securing the roller attachment.

### 1-Part Cartridges

A 1-part cartridge receives a handle at its proximal end and a tool-head at its distal end. A 1-part cartridge is generally a “brush-head cartridge” for painting. As used herein, a “cartridge” generally refers to a 1-part cartridge unless context indicates otherwise.

The distal handle portion may have a face with a recess for receiving a shaft of the cartridge, the shaft and recess being alignable along the longitudinal axis of the distal handle, the recess being configured so that the shaft is rotatable in the recess.

In any embodiment, a cartridge according to the inventive subject matter may have a face with one or more engagement elements that engage with complementary engagement elements on an opposing distal-end surface of the handle so that the cartridge may be rotated around the axis at least 90 degrees from a first position to a second position. In any embodiment, a handle according to the inventive subject matter, the complementary engagement elements may lockably engage in a plurality of positions to fix the position of the cartridge relative to the handle.

In any embodiment, a cartridge according to the inventive subject matter may be configured to receive the proximal and of a ferrule. The cartridge may have an offset surface. For example, it may have an offset of approximately 15 mm from the distal end rearwardly, terminating with an outer edge approximating the outer edge of the ferrule, for a smooth transition between cartridge and ferrule. The ferrule and cartridge may be crimped together at 4 four outward corners, into four debossed recesses.

### 2-Part Cartridges

A 2-part cartridge is an extension cartridge with has all of the elements of a cartridge without a tool, e.g., a brush, attached and it includes a recessed receiver to capture a removable or replaceable “insert cartridge” or “refill cartridge.” The proximal face with shaft, extension cartridge, plus brush insert cartridge make up a 2-part brush-head cartridge, which may be referred to as a “brush-head cartridge.” The extension cartridge replaces the proximal portion of a 1-part cartridge, and the insert cartridge replaces the distal portion of the 1-part cartridge.

In any embodiment, the extension cartridge and insert cartridge may have tangency from the distal end of the extension cartridge and the proximal end of the brush ferrule juncture at the distal end of the of the finger and thumb rest area of the insert cartridge. In any embodiment according to the inventive subject matter, the extension cartridge may have a receiver channel disposed to receive an insert cartridge. The walls of the receiver channel may be configured slightly offset from the insert cartridge for a secure fit. And they may have mirrored, embossed spherical bumps centered on the inner vertical walls to receive complementary deboss features on the insert cartridge to retain the insert cartridge.

In one possible embodiment according to the inventive subject matter, the insert cartridge includes at least three body sections. A proximal body section has a proximally extending post and rib feature and a spherical deboss which are insertable proximally into the recessed receiver of an extension cartridge, and a mating edge that abuttingly connects to the extension cartridge. A medial section of the insert cartridge has a surface that is configured to receive the user's fingers. It may be outwardly offset from the distal and proximal sections. The surface edge of the medial section at the rearward facing edge may be a mirror to the face of the extension cartridge. The surface edge at the forward-facing distal and of the medial surface may be a relative equivalent to the rearward-facing surface edge of the ferrule. The surface of the medial surface may have tangency at its proximal end to the cartridge distal end, and tangency to the distal surface edge, with a curved continuous transition from the extension cartridge to the ferrule.

In any embodiment, a proximal section of the insert cartridge may be configured to receive the proximal end of a ferrule. In any embodiment, the ferrule and proximal section of the insert cartridge may be fixed together. For instance they may be crimped together at 4 outward corners, into four debossed recesses on the proximal section, near the medial section.

### 3-Part Cartridges

In some embodiment a cartridge may be an assembly of three or more parts. Taking a three-part cartridge as an example, the cartridge may be further divided to include a separate “face”, insert cartridge receiver, sometimes referred to herein as a “transition”, and an “insert cartridge.” The three-part cartridge assembly (or any other cartridge) may include a proximal shaft that is alignable along the longitudinal axis of the distal handle, with the recess of the handle being configured so that the shaft is rotatable in the recess.

In one possible embodiment, the inventive subject matter is directed to 1-, 2- or 3-part cartridge that includes an insert cartridge having a proximal shaft that is alignable along the longitudinal axis of the distal handle, the recess of the handle being configured so that the shaft is rotatable in the recess.

The cartridge has a proximal or rearward-facing face that has one or more engagement elements that engage with complementary engagement elements on an opposing surface of a handle recess so that the cartridge may be rotated around the axis at least 90 degrees from a first position to a second position. The complementary engagement elements may lockably engaging in a plurality of positions to fix the position of the cartridge relative to the handle.

In any embodiment wherein the extension cartridge is cosmetically divided into two permanently connecting components, the cartridge receiver portion is known as the “transition”, while the rear facing portion with its face, shaft and engaging elements for the opposing engaging elements of the handle, is known as the face”. Together, these make up the extension cartridge.

In any embodiment, the insert cartridge may be the same on 1-part, 2-part and 3-part cartridges.

### Vertical Application Cartridge

There are many instances where painting in a vertical orientation is most or all of a particular painting job, such as vertical siding, fencing, and decking. Additionally, in Europe, the Middle East, Africa and Latin America, a vast majority of paint brush-heads have square, or flat brush-heads, not angled brush-heads, which are more common in the United States and Canada. Painting with a vertical motion of the arm creates strain and fatigue in the shoulder and places additional leverage on the brush head, creating additional tension in the fingers, hand, arm, and shoulder of the user. Painting in a vertical motion with an angled brush head increases the tension in the fingers, hand, arm, and shoulder of the user, due to the forces created by the angled and of the brush head. In one possible embodiment, the inventive subject matter is directed to a vertical application cartridge is configured with the insert cartridge having horizontal orientation, and its design was intended to be used exclusively with a flat (non-angled) brush-head, in a vertical motion, in a motion from head to toe, and vice versa, whether painting on a vertically oriented surface, such as a wall, or a horizontally oriented surface, such as decking.

In any embodiment, a vertical application cartridge may include multiple parts, for example, it may include three parts: a face, a bulbous base or “transition”, and an insert cartridge receiver. The face profile of the rearward-facing proximal face may transition between the outward-most, non-abutting, proximally-facing surfaces of the bulbous base and horizontal insert cartridge receiver.

In any embodiment, the insert cartridge receiver base may connect abuttingly to the top of the bulbous base, with the insert cartridge receiver bottom edge located approximately at the outer tangency points of the upper finger rest areas of the bulbous extension cartridge.

In any embodiment, the distal end of the rearward-facing face may connect abuttingly, permanently, to a combination of the bulbous transition and insert cartridge receiver.

In any embodiment, the face may have one or more of the following features. The face may be configured with a shaft alignable along the longitudinal axis of the distal handle, the recess of the handle being configured so that the shaft is rotatable in the recess. Its rearward-facing face may have one or more engagement elements that engage with complementary engagement elements on an opposing surface of the handle recess so that the cartridge may be rotated around the axis at least 90 degrees from a first position to a second position. The complementary engagement elements may lockably engage in a plurality of positions to fix the position of the cartridge relative to the handle. In any embodiment, the face may have four pass-through holes at 90-degree intervals, two vertical, two horizontal, to receive the shaft of an internal lock feature of the handle.

In any embodiment, the rearward-facing face of the bulbous base may extend through the rearward-facing face of the vertical application cartridge, and the forward-facing face of the handle may mirror each other. In any embodiment, the bulbous base and face of the vertical application cartridge, and the face of the handle pull tangency from the above described surface edges extending in the opposite direction from their respective abutting faces, creating a curve continuous surface. In any embodiment, the bulbous base may extend distally to the average length of the forefinger distal phalanx of a person with average size hands. In any embodiment, the distal end of the bulbous base may have a 180-degree radial curvature from edge to edge distally, closing off the end of the transition, disposed to create a smooth comfortable surface for the user.

In any embodiment, the insert cartridge receiver and insert cartridge may have tangency from the distal end of the extension cartridge and the proximal end of the brush ferrule juncture at the distal end of the of the finger and thumb rest area of the insert cartridge.

In any embodiment, the extension cartridge may have a receiver channel disposed to receive an insert cartridge, the walls of the receiver channel are configured slightly offset from the rearwardly-extending post and rib features of the insert cartridge for a secure fit and stability of the insert cartridge, and mirrored embossed spherical bumps centered on the inner vertical walls to receive a complimentary deboss features on the insert cartridge to retain the insert cartridge.

### Roller Cartridge

Rollers have become an essential tool for every painter. Smaller rollers are now often used for trim painting, furniture painting and other small painting projects. Roller attachments for the handles of the inventive subject matter may be in the form of a cartridge, on an insert connecting to a cartridge, with the properties below.

In one possible embodiment, the inventive subject matter is directed to a roller cartridge that includes an insert and a rod, plus an optional roller pad. In any embodiment, the roller rod may be configured to receive any size roller pad. In any embodiment, the roller extension cartridge may be configured to insert in an extension cartridge, or to an insert cartridge receiver.

In any embodiment, the roller insert may have two distinct regions, the base, and the cartridge post features. The insert base may have an elliptical shape distal end surface profile, and an outer proximal end surface profile, mirroring the outer distal surface profile of an extension cartridge or an insert cartridge receiver. The cartridge base shape may be contoured from its proximal to distal end.

In any embodiment, the proximal portion of the roller insert may have rearward extending post and rib features, including engagement elements that engage with complementary engagement elements on an opposing surface of an extension cartridge, or insert cartridge receiver. In any embodiment, these complementary engagement elements may be in the form of spheres, debossed and embossed. In any embodiment, the insert cartridge may be disposed to be inserted in an extension cartridge or insert cartridge receiver. In any embodiment, both an extension cartridge and insert cartridge receiver have inner walls which slightly offset the post and rib features of the insert cartridge, providing a secure fit, and stability of the roller when in use.

In any embodiment the rod may have one or more of the following features. The rod of the roller may be over-molded by the distal and of the insert. The rod may extend distally along a longitudinal axis, then bent laterally 90 degrees, extending laterally slightly farther than the half the length of its intended roller pad, then bending distally 90 degrees, extending distally, then receiving a final inward 90-degree bend, extending slight farther than the length of the roller pad, positioning the center of the roller pad in the distal longitudinal axis, the lateral oriented distal end of the rod disposed to receive a roller pad.

In any embodiment the roller rod may have one or more of the following features. A roller rod may protrude distally from the insert, is over-molded in the insert. The roller rod may be formed with three 90-degree bends at varying lengths to form its final shape. A roller pad may be insertable into the rod at its open end. The diameter of the rod may be selected from a standard in the industry, which allows the user to buy a roller pad of their choice. In other embodiments there may be size and/or angle changes to the roller and rod. Because a roller is generally not needed to be rotated, a lock feature may be used with the roller attachment. The roller insert may have a hang hole that allows the roller to hang to dry, for storage, or for hanging on a retail hook/peg. The roller may easily be configured in a range of sizes.

### Counterweight

Because of the design of a paint brush, including the paint brush design of the inventive subject matter, much of the weight is located distally from the hand. Add to this, the weight of the paint at the end of the brush, it can put strain on the user's fingers, hand, wrist, arm, and shoulder when the arm is reaching and in repetitive motion for extended periods of time. To offset this distally-oriented weight, a counterweight device can be adapted to different handle embodiments of the inventive subject matter, with the weight of the counterweight positioned on top of the handle, rearward of the hand rest area thus assisting to offset the weight of the brush to mitigate the potential strain to the user's body.

In some embodiments, a handle according to the inventive subject matter may include a counterweight that includes one or more of the following features. The detachable counterweight may have a main body that includes a riser post extending from a cylindrical base rearwardly and upwardly, having adjoining mirrored cross beams extending laterally and rearwardly with gussets between the riser post and cross beams. The crossbeams may be disposed to receive mirrored counterweight plugs at the lateral distal ends of the cross beams. The crossbeams may have snap lock features at their distal ends that capture an interior shelf-like feature within the cored center of the counterweight plug, permanently connecting the counterweight to the cross beam. Additionally, the counterweight and cross beam may have complementary alignment features to consistently align the orientation of the counterweight plug when attached. The outer end of the counterweight may be covered by an adhesive backed emblem, with or without a name or logo. the main body of the counterweight has a cylindrical shaped base with a downwardly extending post connected to a rectangular block creating a keylock mechanism. The distance between the cylindrical base and the top of the rectangular key lock mechanism may be slightly longer than the wall thickness of the accessory port, which is found on either a handle top or a nonsymmetrical handle support strap central pad. The key lock feature rectangular box may be configured with mirrored debossed spherical shapes on the upward facing edge of the rectangular block, which engage with complementary embossed features on the underside of the accessory port on top of a handle, or on the underside of the accessory port on the central pad of a nonsymmetrical handle, securing the position of the counterweight. The counterweight may be secured to the handle or strap by orienting the counterweight 90 degrees over the accessory port passing the key lock rectangular feature through the accessory port pass-through and turning the counterweight 90 degrees clockwise until its leading-edge contacts the stop feature on the accessory port, engaging the complementary spherical connectors.

### LED Light or LED-Integrated Counterweight

In some embodiment, the inventive subject matter is directed to a handle, cartridge, and/or tool having integrated lights, e.g., LED lights. For example, a handle may include fixed or detachable lights. In some embodiments, the lights may be combined with counterweights. An LED-integrated counterweight may be based on counterweights described above. For instance, the LED/counterweight assembly may include a main body having a riser post extending from a cylindrical base rearwardly and upwardly, having adjoining mirrored cross beams extending laterally and rearwardly with gussets between the riser post and cross beams. The two mirrored LED light assemblies may be located on the front outer distal end of the crossbeams, and angled slightly downward to project at an assumed center of the distal end of a paintbrush head. The center of the crossbeams may be configured with a recessed battery compartment and lid, configured to receive a battery, within the crossbeam area housing the internal wiring.

The main body may be formed of metal, e.g., steel, or other heavy material, acting as the weight of the counterweight.

In any embodiment relating to counterweights or LED-counterweights, the main body may have one or more of the following features. It may have a cylindrical shaped base with a downwardly extending post connected to a rectangular block creating a keylock mechanism. The distance between the cylindrical base and the top of the rectangular key lock mechanism may be slightly longer than the wall thickness of the accessory port, which is found on either a handle top or a nonsymmetrical handle support strap central pad. The key lock feature rectangular box may be configured with mirrored debossed spherical shapes on the upward facing edge of the rectangular block, which engage with complementary embossed features on the underside of the accessory port on top of a handle, or on the underside of the accessory port on the central pad of a nonsymmetrical handle, securing the position of the counterweight. The counterweight may be secured to the handle or strap by orienting the counterweight 90 degrees over the accessory port passing the key lock rectangular feature through the accessory port pass-through and turning the counterweight 90 degrees clockwise until its leading-edge contacts the stop feature on the accessory port, engaging the complementary spherical connectors.

### Ball Socket

In some embodiments the inventive subject matter is directed to a handle and/or cartridge assembly that includes a pivoting ball socket extension. In any embodiment, the pivoting ball socket extension may have one or more of the following features. It may have a distally extending assembly that includes multiple sections with a distal most and configured to connect to a tool, including attachable extension cartridge configured with complementary engagement elements having an opposing surface of the handle so that the cartridge may be rotated around the axis at least 90 degrees from the first position to the second position, the complementary engagement elements lockable by engaging in plurality of positions to fix the position of the cartridge relative to the handle. The pivoting ball socket may include a detachable extension cartridge with an elliptical shaped forward face wherein the rearward (proximal) facing face of the detachable extension cartridge is a mirror to the forward (distal) facing face of the handle, with the assembly of handle and cartridge having a curved continuous surface between handle and extension cartridge within the finger and thumb rest areas. The pivoting ball socket may be configured with a tool head that can pivot 180 degrees from its center joint, can be rotated 360 degrees and has a chassis base also capable of rotating 360 degrees. The ball socket movement actuation may be engageable and disengageable by a cam lever. The distal end may be configured to receive an insert cartridge. The distal end may be configured to receive a paintbrush attachment. The distal end may be configured to receive a roller attachment.

### Telescopic Extension

In some embodiments, the inventive subject matter is directed to handles or cartridges configured with or to receive telescopic extensions, which may support a tool. The handle may be configured to removably or fixedly receive a telescopic extension. In any embodiment, the extension that is combined or combinable with a handle or cartridge may have one or more of the following features. The distal most end of the extension may be configured to receive interchangeably multiple attachments including a detachable extension cartridge. The extension may be configured to receive an insert cartridge. The detachable extension cartridge may have an elliptically shaped forward facing face. The rearward facing face of the detachable extension cartridge may be a mirror to the forward-facing face of a handle of the inventive subject matter, the surfaces of the extension cartridge and handle having curved continuous surfaces extending longitudinally through the finger and thumb rest areas. The distal end may be configured to receive a pivoting ball socket receiver configured to connect with a tool or to an insert cartridge. The telescopic extension may extend distally, with one or more tubes housed within the other, being engaged and disengaged with a cam lever. The telescopic extension may include a detachable extension cartridge configured with the engagement elements that engage with complementary engagement elements on an opposing surface of the handle so that the cartridge may be rotated around the axis at least 90 degrees from a first position to a second position.

In any embodiment of the inventive subject matter contemplated herein, the complementary engagement elements may lockably engage in one, two, three, four or any number of positions to fix the position of a cartridge or tool relative to the handle.

### Straps

The inventive subject matter has a handle that allows the user's fingers to be free from gripping in most instances, even so a user cannot release the fingers while the handle is pointed downward, or if needed to significantly grab, or hold something other than the handle. To further free the user's hand and secure the handle in any orientation without gripping with the fingers, in some embodiments, the inventive subject matter is directed to a handle-strap system. These straps allow the fingers on the hand of the handle to be used for when needed for support, stability, on a ladder for example, for convenience, or simply for resting the arm.

### Tether

In some embodiments, the inventive subject matter is directed to handle with a tether system. The tethered support is not intended or designed to create a tighter fit of the handle, rather its intended use is to allow the user to release the handle, when and if they need to use the fingers of the hand holding the handle, for safety or convenience purposes.

In one possible embodiment, the tether system includes a locking base, a tether, and a plastic eyelet base with a silicone pad. In any embodiment, the tether system may include one or more of the following features. The locking base may have a key lock feature with a cylindrical base with a downward extending post connecting to a rectangular lock feature, the distance between the bottom face of the cylindrical base and the top of the lock feature being slightly more than the wall thickness of the accessory port on top of the handle. The tether may have a spherical tip at its proximal end, which is inserted through the lock base. Its distal end may include multiple equally sized and spaced spherical protrusions located towards the distal end of the strap configured to connect through the eyelet on the plastic base of the silicone pad to allow for adjustability of the strap length to accommodate users of all hand sizes. To adjust the length of the tether strap, the user first places the silicone pad it the desired location on the metacarpal region of the back of the hand, then pulling the tether in the other, to pull the speres through the eyelet until the desired length is achieved. The strap may be used for both right-handed and left-handed users.

### Ratchet Strap

In some embodiments, the inventive subject matter is directed to a handle with an adjustable ratcheting strap. In any embodiment, the ratchet strap may have one or more of the following features. The strap may connect on both the top and bottom of the handle on the accessory port on top of the handle and the accessory mount in the plug on the bottom of the handle. The bottom end of the handle may have a shaft mounted vertically on the inner side of the strap, the shaft being inserted into the handle plug accessory mount. The ratchet strap may have a spring-loaded lock feature having a lower key lock base that is insertable into the accessory mount on the handle top. The strap ratchet may have saw-like teeth which are insertable into the spring loaded lock feature. The user can place their hand on the handle and pulls the loose end of the strap through the spring loaded lock feature, engaging the teeth on the strap with the lock feature until the desired feel is achieved. The strap may be loosened by pushing down the lever proximally to the hand, thereby releasing the spring loaded lock feature allowing the strap to be adjusted or removed. This adjustable strap may be used by both right-handed and left-handed users. The strap may be produced with soft elastomers for a greater comfort and security to the user.

### Flex Strap

In some embodiments, the inventive subject matter is directed to a handle with flexible straps. The straps include supports configured with a shaft that rises vertically from the lower body of the strap. The shaft may be made insertable into a handle plug accessory receiver on the bottom of the handle. The strap may have a continually contoured shape configured to receive the metacarpal region on the back of a user's hand, allowing the user to use their fingers in situations where a third point of contact is necessary for safety or convenience. The support may be used for both right-handed and left-handed users. The support may be produced with a combination of hard plastics and soft elastomers, providing greater comfort and security for the user.

### Non-Symmetrical Handle

The nonsymmetrical (asymmetrical) handle is design for either a right or left-handed user. The form allows the hand to rest in natural, neutral states, providing greater comfort and reduced fatigue to the user.

An embodiment of the handle may be configured so that when the intended user is gripping the handle with the palmar saddle against the palm rest area, the face of the handle is proximal to the user's first knuckle, known as the proximal interphalangeal joint. The handle may have one or more contoured areas which, on opposing lateral sides of the body, include a pair of upper and lower ridges flaring from the body and extending longitudinally along each of the opposing sides of the body. Each pair of ridges defines finger and thumb rest areas. Each pair of ridges may be configured to abuttingly engage (1) the respective fingers or thumb placed in the rest areas during use, and/or (2) a hand rest area having a bottom-facing surface disposed on the body above the thumb and finger rest areas and above the handgrip, the bottom-facing surface extending longitudinally, rearwardly from the body beyond the finger and thumb rest areas, the bottom surface extending laterally wider than the body so as to be configured to cover the thenar webspace of the intended user.

In any embodiment, finger and thumb rest areas respectively may be configured with outwardly facing concave surfaces, with the handle's bottom facing surface of the hand rest area being concave along its longitudinal axis of the body. In any embodiment, a lower ridge may have a portion distally offset from the upper ridge, a longitudinal finger and thumb rest area divide it into two parts: a rearward handle and a forward cartridge, the handle's forward facing surface ending at a juncture slightly rearward of the first knuckle of the forefinger of the user.

In any embodiment, the rearward handle and the forward cartridge may have mirrored surface edges, which are mirrored both vertically and horizontally by planes crossing at the center of the handle receiver channel and cartridge shaft, allowing a blended curve-continuous surface at the juncture, extending the longitudinal finger and thumb rest areas to continue from the rearward handle to the forward cartridge.

In any embodiment, a pair of upper and lower ridges may be included, with the upper ridge flaring from the body and extending longitudinally along each of the opposing sides of the body, while the lower thumb rest area changes from a convex to a contoured shelf-like surface, the lower finger rest area contouring downward and rearward towards the palmar rest area, producing an area able to receive all fingers of the user's hand.

In any embodiment, each pair of ridges may define respective finger and thumb rest areas, each pair of ridges being configured to abuttingly engage the respective fingers or some placed in the rest area during use, the surface of the cartridge having tangency distally from its rearward-facing face, the surface of the handle having tangency proximally from its forward-facing face within the finger and thumb rest areas, the handle and cartridge surfaces having a curve continuous surface through the finger and thumb rest areas.

In any embodiment, the juncture of the face of the handle and face of the cartridge may be at a point proximal to the first joint of the user's forefinger, allowing the user to rotate the cartridge using the fingers of the hand holding the handle. The cartridge rotation generally may be initiated with the user's middle finger by bending the middle finger laterally from its first knuckle while contacting the surface of the lower finger and thumb rest area of the cartridge and continuing to bend the middle finger across the lower portion of the face of the handle until the palmar surface of the middle finger is abuttingly coming to rest on the handle face. The natural position of the user's middle finger from that action places the finger abuttingly against the two mirrored outward-most surface regions of the finger and thumb rest areas of that side of the cartridge, creating a natural stop or support position for the cartridge, preventing the cartridge from inadvertent and unwanted rotation. The rotation may continue by the forefinger moving on top of the horizontally oriented cartridge and pulling downward. This may be done by both right-handed and left-handed users. The angle of the palmar saddle area of the handle relative to the angle of the finger rest areas allows the user to maintain a neutral wrist and hand position regardless of the orientation of the toolhead, or in painting the brush head regardless of the direction of the painting stroke.

In any embodiment, the handle assembly may be divided into parts, or regions, including a separate top, face, bottom plug, and two halves. The separate face may be produced in different lengths to accommodate users of all band sizes. The shape of the handle rearward of its forward face may have multiple shapes to serve multiple different functions.

In some embodiments the inventive subject is directed to handle and/or cartridge with an integrated lock mechanism, which locks a cartridge in a given position at selected intervals. For example, the lock feature may be assembled by mating the top and bottom halves of the mechanism. The lower body may be placed below the lock feature opening on the distal front of the handle top and connected by lowering a push button through the handle top opening, into a recessed area on top of the lock body, and snapping the two mirrored male snaps of the push button into the corresponding recesses on the body. The lock mechanism is configured with a cantilevered push button lock assembly. The lock assembly includes: a top push button, a main body including, a distally longitudinal shaft, two mirrored slide rails, and two mirrored lock stop posts, At rest, in its disengage position, the two stop lock posts lay rearward of the two mirrored lock mechanism position stops, located on the underside of the handle top. To engage the lock, the push button is depressed and pushed forward to its distal most position, passing through the lock pass-through on the face of the handle and into one of the extension cartridge face lock post pass-throughs. With the lock stop post of the lock mechanism having traveled past the lock mechanism position stop, the button is released, securing it in the cartridge. To disengage the lock, the procedure is reversed.

An embodiment of the handle may have separate lower proximal and upper distal sections, which are at least partially separated from each other by an intermediate section having a greater degree of flexibility than the proximal section. These sections may be connected by a strut that is bendable within a vertical plane of the handle, which can adjust the distance of the angle between the hand rest area and the lower palmar saddle breast area, to accommodate different hand sizes. The upper and lower regions may be over-molded with a soft elastomer material, and/or textured, providing greater comfort and stability to the user.

In some embodiments, a structural support strap of the inventive subject matter may include an accessory port that can receive strap features, e.g., counterweights, LED lights, LED-integrated counterweights, a clock or smart watch attachment, and so on. One or more of the following features may be included in the structural support strap. An accessory port may be located in the top of the central pad of the structural strap. In may be configured with a twist-turn keylock mechanism Opposing, mating alignment stop features on the handle accessory port and accessory may be included to secure the given accessory in position. The accessory may be lowered through an opening in the accessory port at a 90-degree angle to its final orientation, then turned 90 degrees clockwise where the leading edge of the key lock feature of the accessory abuttingly connects to a wall within the accessory port, and complementary opposing mating features of the accessory and accessory port further secure the accessory in its position.

In some embodiments, a handle has a distally extending support strap connected at its proximal end area on the top of the handle. In any embodiment, the support strap may have one or more of the following features. The strap may contact multiple surfaces of the metacarpal region of the dorsal side of the user's hand, allowing the user to release their grip and keep the handle stable and connected to the user's hand. It may accommodate users of varying hand sizes. It may have a plurality pads regionally spaced across some or all of the metacarpal region of the dorsal side of the user's hand. For instance, one or more pads may be arranged to correspond to the pollicis brevis tendon area of the thumb. The underside of each pad can be affixed with soft elastomers for more comfort and security to the user. Pads may be affixed permanently or removably (replaceably). Any regional pad may be disposed on a bar consisting of adjustment or adjustable spaces, allowing the user to adjust the position of the pads around the metacarpal region. Additionally, the adjustable bar pads may be contoured to the shape of the person's hand. The support strap may be raised and lowered by a hinge in the top of the handle for easy access and release.

### BRIEF DESCRIPTION OF THE FIGURES

The appended Figures show embodiments of the inventive subject matter unless noted as prior art.

FIG. 1a shows in highlight the palm of the hand.

FIG. 1b shows in highlight the soft area below the thumb, which is part of the palm is known as the Thenar Eminence.

FIG. 1c shows in highlight (1) the fleshy area between the thumb and forefinger, which area is known as the Thenar Webspace, and (2) the Extensor Pollicis Brevis Tendon Area, which extends distally from the Metacarpophalangeal Joint of the thumb.

FIG. 1d shows in highlight the area bordering the inner edge of the Thenar Webspace, the inner edge of the Thenar Eminence, the out edge of the palm extending from the lower edge of the Thenar Eminence to the lower edge of the finger knuckle joints in the hand to the Thenar Webspace, which area is known as the Palmar Saddle.

FIG. 1e shows in highlight the area on the top of the hand bordered by the Thenar Webspace profile line and the junction of the bones of the thumb and forefinger, which area forms a delta shape and is known as the Dorsal Saddle.

FIG. 1f shows in highlight the Metacarpal Region on the back of the hand, wrapping to the area of the sides of the hand.

FIG. 2a shows the hand and wrist in their neutral states with the arm extended.

FIG. 2b shows a person holding a prior art paintbrush with a healthy, typical wrist bend, noting the angle of the brush head is pointed in a downward direction.

FIG. 2c shows a person holding a prior art paintbrush with an unhealthy wrist bend.

FIG. 2d shows a person holding an embodiment of the inventive subject matter with a neutral wrist bend.

FIG. 2e shows a left elevation view of a person holding the embodiment of FIG. 2d, with a dashed line representing the juncture of the split of the handle and cartridge of the inventive subject matter.

FIG. 2f shows a left elevation view of a person holding the handle portion of the embodiment of

FIG. 2d with the forefinger bent laterally across the distal forward-face of the handle of the inventive subject matter.

FIG. 3a shows front left isometric view of a person with the embodiment of FIG. 2d resting on the dorsal saddle, and in the palmar saddle and thenar webspace, while rotating the distally oriented brush-head cartridge using the middle and forefinger only.

FIG. 3b shows front left isometric view of a person with the embodiment of FIG. 2d resting on the dorsal saddle, and in the palmar saddle and thenar webspace, while rotating the distally oriented brush-head cartridge using the middle and forefinger only.

FIG. 3c shows front left isometric view of a person with the embodiment of FIG. 2d resting on the dorsal saddle, and in the palmar saddle and thenar webspace, while rotating the distally oriented brush-head cartridge using the middle and forefinger only.

FIG. 3d shows front left isometric view of a person with the embodiment of FIG. 2d resting on the dorsal saddle, and in the palmar saddle and thenar webspace, while rotating the distally oriented brush-head cartridge using the middle and forefinger only.

FIG. 3e shows front left isometric view of a person with the embodiment of FIG. 2d resting on the dorsal saddle, and in the palmar saddle and thenar webspace, while rotating the distally oriented brush-head cartridge using the middle and forefinger only.

FIG. 3f shows front left isometric view of a person with the embodiment of FIG. 2d resting on the dorsal saddle, and in the palmar saddle and thenar webspace, while rotating the distally oriented brush-head cartridge using the middle and forefinger only.

FIG. 3g shows a front-left isometric view of the embodiment of FIG. 2d with a person having rotated the distally forward-facing brush-head cartridge 90 degrees, with their middle finger engaging the outer surface of the brush-head cartridge finger and thumb rest areas, with the middle finger acting as stabilizing support, preventing the brush-head cartridge from unwanted rotation in either direction.

FIG. 4a shows a right elevation view of left and right sides of the embodiment of FIG. 2d with the finger/thumb rest areas of the handle and cartridge shown.

FIG. 4b shows a left elevation view of the embodiment of FIG. 2d with finger/thumb rest areas of the handle and brush-head cartridge shown.

FIG. 4c shows a rear elevation view of the embodiment of FIG. 2d with the palm rest area of the handle shown.

FIG. 4d shows a back elevation view of the embodiment of FIG. 2d with a dorsal saddle rest area of the handle shown.

FIG. 5a shows a right elevation view of prior art and its concave finger and thenar eminence regions called out.

FIG. 5b shows a right elevation view of a person holding the prior art as intended in the prior art design.

FIG. 5c shows a top elevation view of a person holding the prior art with the forefinger extended, with a dashed line representing the juncture of the division between the handle and brush-head cartridge of the prior art.

FIG. 5d shows a right elevation view of the prior art resting on a horizontal surface with a person's hand under the handle area, showing the concave finger and thenar eminence regions and where they relate to user's hand as the design was intended.

FIG. 5e shows a person holding the prior art, with the brush head oriented horizontally, with their forefinger extended, with the juncture of the handle and brush-head cartridge (thick black line) above the forefinger, clearly showing the forefinger cannot effectively rotate the brush-head cartridge.

FIG. 5f shows a top elevation view of a person holding the prior art, with the brush head oriented horizontally, as also shown in FIG. 5e, with the forefinger extended, clearly showing the forefinger cannot effectively rotate the brush head cartridge.

FIG. 6a shows a right elevation view of an embodiment of a complete 3-part brush assembly of the inventive subject matter.

FIG. 6b shows a right elevation view of an insert (a brush insert) cartridge of a 3-part brush of the embodiment of FIG. 6a.

FIG. 6c shows a right elevation view of a brush and extension cartridge of a 3-part brush of the embodiment of FIG. 6.

FIG. 6d shows a brush-head cartridge of the 3-part brush of the embodiment of FIG. 6a.

FIG. 6e shows an extension cartridge of a 3-part brush of the embodiment of FIG. 6a.

FIG. 6f shows a fixed position handle of the embodiment of FIG. 6a.

FIG. 6g shows and isometric view of the curve continuous surface between the handle and brush-head cartridge of a 3-part brush of the embodiment of FIG. 6a.

FIG. 7a shows right elevation view, with partial internal details revealed for a holder portion, of a 3-part brush of an embodiment.

FIG. 7b shows an exploded right elevation view of a 2-part brush-head cartridge of the embodiment of FIG. 7a.

FIG. 8a shows a right elevation view of a complete 2-part brush of an embodiment of the inventive subject matter.

FIG. 8b shows a right elevation view of a handle of the embodiment of FIG. 8a.

FIG. 8c shows a right elevation view of a 1-part brush-head cartridge of embodiment of FIG. 8a.

FIG. 8d shows a back elevation view of a 1-part brush-head cartridge of the embodiment of FIG. 8a.

FIG. 8e shows an isometric view of the crimp debosses on a brush insert of the embodiment of FIG. 8a.

FIG. 8f shows an isometric view of a ferrule crimped onto the handle of a brush of the embodiment of FIG. 8a.

FIG. 8g shows a right elevation view of a handle of the inventive subject matter.

FIG. 9a shows a front elevation view of an embodiment of a handle of the inventive subject matter, with its distally oriented, forward-facing face, and its symmetrically mirrored quadrants, whereby each quadrant is a mirror of neighboring quadrant.

FIG. 9b shows a front elevation view of a complementary brush-head cartridge usable with the embodiment of FIG. 9a, with its distally oriented, rear-facing face, and its symmetrically mirrored quadrants, whereby each quadrant is a mirror of neighboring quadrant.

FIG. 9c shows the face quadrant of a handle of the embodiment of FIG. 9a.

FIG. 9d shows the face quadrant of a cartridge of the embodiment of FIG. 9b.

FIG. 10a shows a right elevation view of an embodiment of a 3-part brush with a distally broad-based flange handle designed for side-to-side movement, with the paddle shape of the lower body providing additional leverage from the user's palm.

FIG. 10b shows a front elevation view of a flange handle of the embodiment of FIG. 10a.

FIG. 10c shows a back elevation view of a flange handle of the embodiment of FIG. 10a.

FIG. 10d shows a right elevation view of a flange handle of the embodiment of FIG. 10a. The left elevation view is a mirror of the right elevation view.

FIG. 10e shows a top elevation view of a flange handle of the embodiment of FIG. 10a.

FIG. 10f shows a bottom elevation view of a flange handle of the embodiment of FIG. 10a.

FIG. 11a shows a front elevation view of an embodiment of a fixed-position handle.

FIG. 11b shows a back elevation view of a fixed-position handle of the embodiment of FIG. 11a inventive.

FIG. 11c shows a top elevation view of a fixed-position handle of the embodiment of FIG. 11a.

FIG. 11d shows a bottom elevation view of a fixed-position handle of the embodiment of FIG. 11a.

FIG. 11e shows a right elevation view of a fixed-position handle of the embodiment of FIG. 11a. The left elevation view is a mirror of the right.

FIG. 12a shows a top elevation view of the top of an embodiment of a fixed-position, articulating, and broad-based flange handles.

FIG. 12b shows a bottom elevation view of the top of the fixed-position, articulating, and broad-based flange handles of the embodiment of FIG. 12a.

FIG. 12c shows a right elevation view of the right side of a fixed-position handle of the embodiment of FIG. 12a.

FIG. 12c shows a left elevation view of the right side of a fixed-position handle of the embodiment of FIG. 12a.

FIG. 13a shows a front elevation view of an embodiment of a handle face.

FIG. 13b shows a right elevation cross-section view of a handle face of the embodiment of FIG. 13a.

FIG. 13c shows a front elevation view of a handle plug of the embodiment of FIG. 13a.

FIG. 13d shows a right elevation cross-section view of the embodiment of FIG. 13a.

FIG. 13e shows a left elevation view of a lock mechanism assembly of the embodiment of FIG. 13a.

FIG. 13f shows a side elevation view of a lock mechanism push button of the embodiment of FIG. 13a.

FIG. 13g shows a left elevation view of a lock mechanism main body (base) of the embodiment of FIG. 13a.

FIG. 14a shows a front elevation view of an embodiment of an extension cartridge.

FIG. 14b shows a back elevation view of an extension cartridge of the embodiment of FIG. 14a.

FIG. 14c shows a top elevation view of an extension cartridge of the embodiment of FIG. 14a. The bottom elevation view is a mirror of the top.

FIG. 14d shows a right elevation view of an extension cartridge of the embodiment of FIG. 14a. The left elevation view is a mirror of the right.

FIG. 15a shows a front elevation view of an embodiment of a brush insert of a 2-part cartridge (3-part brush) version.

FIG. 15b shows a back elevation view of a brush insert of a 2-part cartridge (3-part brush) version of the embodiment of FIG. 15a.

FIG. 15c shows a top elevation view of a brush insert of a 2-part cartridge (3-part brush) version of the embodiment of FIG. 15a. The bottom elevation view is a mirror of the top.

FIG. 15d shows a right elevation view of a brush insert of a 2-part cartridge (3-part brush) version of the embodiment of FIG. 15a. The left elevation view is a mirror of the right.

FIG. 16a shows a front elevation view of an embodiment of a vertical application extension cartridge.

FIG. 16b shows a back elevation view of a vertical application extension cartridge of the embodiment of FIG. 16a.

FIG. 16c shows a right elevation view of a vertical application extension cartridge of the embodiment of FIG. 16a.

FIG. 16d shows a left elevation view of a vertical application extension cartridge of the embodiment of FIG. 16a.

FIG. 16e shows a top elevation view of a vertical application extension cartridge of the embodiment of FIG. 16a.

FIG. 16f shows a bottom elevation view of a vertical application extension cartridge of the embodiment of FIG. 16a.

FIG. 16g shows in isometric view of a brush with a vertical application system of the embodiment of FIG. 16a.

FIG. 16h shows a right elevation view of a vertical application brush head cartridge of the embodiment of FIG. 16a.

FIG. 17a shows a front elevation view of an embodiment of a non-symmetrical handle.

FIG. 17b shows a back elevation view of a non-symmetrical handle of the embodiment of FIG. 17a.

FIG. 17c shows a right elevation view of a non-symmetrical handle of the embodiment of FIG. 17a.

FIG. 17d shows a left elevation view of a non-symmetrical handle of the embodiment of FIG. 17a.

FIG. 17e shows a top elevation view of a non-symmetrical brush assembly of the embodiment of FIG. 17a.

FIG. 17f Shows a person with a non-symmetrical brush of the embodiment of FIG. 17a.

FIG. 18a shows a front elevation view of an embodiment of a complete 2-part brush, with handle with built-in LED lights.

FIG. 18b shows a back elevation view of a complete 2-part brush, with handle with built-in LED lights, of the embodiment of FIG. 18a.

FIG. 18c shows a top elevation view of a complete 2-part brush, with handle with built-in LED lights, of the embodiment of FIG. 18a.

FIG. 18d shows a bottom elevation view of a complete 2-part brush, with handle with built-in LED lights, of the embodiment of FIG. 18a.

FIG. 18e shows a right elevation view of a complete 2-part brush, with handle with built-in LED lights, of the embodiment of FIG. 18a. The left elevation view is a mirror of the right elevation view.

FIG. 18f shows a right elevation view of a handle with built-in LED lights, of the embodiment of FIG. 18a.

FIG. 19a shows a front elevation view of an embodiment of an articulating handle.

FIG. 19b shows a back elevation view of an articulating handle of the embodiment of FIG. 19a.

FIG. 19c shows a right elevation view of an articulating handle of the embodiment of FIG. 19a.

FIG. 19d shows a left elevation view of an articulating handle of the embodiment of FIG. 19a.

FIG. 19e shows a top elevation view of an articulating handle of the embodiment of FIG. 19a.

FIG. 19f shows a bottom elevation view of an articulating handle of the embodiment of FIG. 19a.

FIG. 20a shows an exploded view of an embodiment of an articulating handle.

FIG. 20b shows a left elevation view of a right top side chassis of an articulating handle of the embodiment of FIG. 20a.

FIG. 20c shows right elevation view of a left top chassis of an articulating handle of the embodiment of FIG. 20a.

FIG. 20d shows a left elevation view of a right bottom side chassis of an articulating handle of the embodiment of FIG. 20a.

FIG. 20e shows right elevation view of a left bottom chassis of an articulating handle of the embodiment of FIG. 20a.

FIG. 21a shows a right elevation cross-section view of an embodiment of a handle with face and body.

FIG. 21b shows a right elevation cross-section view of a handle of the embodiment of FIG. 21a.

FIG. 21c shows a right elevation cross-section view of a handle of the embodiment of FIG. 21a.

FIG. 21d shows a right elevation cross-section view of a handle and a 1-part cartridge on the left of the handle of the embodiment of FIG. 21a with an extended length face and body attached and a 1-part cartridge on the left of the handle.

FIG. 21e shows a right elevation cross-section view of a complete 2-part brush of the embodiment of FIG. 21a with an extended length face replacing the shorter standard face body.

FIG. 22a shows a front elevation view of an embodiment of a roller attachment assembly of the inventive subject matter.

FIG. 22b shows a back elevation view of a roller attachment assembly of the embodiment of FIG. 22a.

FIG. 22c shows a top elevation view of a roller attachment assembly of the embodiment of FIG. 22a. (The bottom elevation view is a mirror of the top elevation view.)

FIG. 22d shows an isometric view of a roller attachment on a handle of the embodiment of FIG. 22a.

FIG. 22e shows a left elevation view of a roller (cartridge) attachment.

FIG. 22f shows a right elevation view of a roller (cartridge) attachment.

FIG. 23a shows a right isometric view of an embodiment of a telescopic extension assembly.

FIG. 23b shows a front isometric view of a threaded cartridge receiver of the embodiment of FIG. 23a.

FIG. 23c shows a back elevation view of a threaded extension cartridge of the embodiment of FIG. 23a.

FIG. 23d shows a right elevation cross-section view of detachable receiver of the embodiment of FIG. 23a.

FIG. 23e shows a telescopic extension assembly with handle with a brush head cartridge, of the embodiment of FIG. 23a.

FIG. 23f shows a telescopic extension assembly with handle with a ball socket attachment containing a 1-part paintbrush cartridge, of the embodiment of FIG. 23a.

FIG. 23g shows a telescopic extension assembly with handle with a ball socket attachment containing a roller cartridge, of the embodiment of FIG. 23a.

FIG. 24a shows a front elevated view of an embodiment of a counterweight assembly of the inventive subject matter.

FIG. 24b shows a back elevated view of a counterweight assembly of the embodiment of FIG. 24a.

FIG. 24c shows a right elevated view of a counterweight assembly of the embodiment of FIG. 24a. The left elevated view is a mirror of the right.

FIG. 24d shows a top elevated view of a counterweight assembly of the embodiment of FIG. 24a.

FIG. 24e shows a bottom elevated view of a counterweight assembly of the embodiment of FIG. 24a.

FIG. 24f shows a top elevation view of a counterweight base of the embodiment of FIG. 24a.

FIG. 24g shows an isometric view of a counterweight plug and its capture shelf of the embodiment of FIG. 24a.

FIG. 24h shows an isometric view of a counterweight plug and its alignment feature of the embodiment of FIG. 24a.

FIG. 24i shows a top elevation view of a counterweight plug with logo emblem badge of the embodiment of FIG. 24a.

FIG. 24j shows an isometric view of a counterweight lock mechanism of the embodiment of FIG. 24a.

FIG. 25a shows a top isometric view of an embodiment of a ratcheting strap.

FIG. 25b shows a top isometric exploded view of a ratcheting strap of the embodiment of FIG. 25a.

FIG. 25c shows a left elevation view of a brush with a ratcheting strap of the embodiment of FIG. 25a.

FIG. 26a shows a top isometric view of an embodiment of a pivoting ball socket assembly.

FIG. 26b shows an exploded isometric view of a pivoting ball socket assembly of the embodiment of FIG. 26a.

FIG. 26c shows a pivoting ball socket assembly on a brush of the embodiment of FIG. 26a.

FIG. 26d shows a side elevation view of a cam lever assembly of the embodiment of FIG. 26a.

FIG. 27a shows a front elevation view of an embodiment of a flexible fixed strap.

FIG. 27b shows a back elevation view of a flexible fixed strap of the embodiment of FIG. 27a.

FIG. 27c shows a right elevation view of a flexible fixed strap of the embodiment of FIG. 27a.

FIG. 27d shows a left elevation view of a flexible fixed strap of the embodiment of FIG. 27a.

FIG. 27e shows a top elevation view of a flexible fixed strap of the embodiment of FIG. 27a.

FIG. 27f shows a bottom elevation view of a flexible fixed strap of the embodiment of FIG. 27a.

FIG. 27g shows a front left isometric view of a brush with a flexible fixed strap of the embodiment of FIG. 27a.

FIG. 28a shows a side elevation view of an embodiment of a tethered silicone pad strap assembly. Each side is a mirror of the other.

FIG. 28b shows a top elevation view of a tethered silicone pad strap assembly of the embodiment of FIG. 28a.

FIG. 28c shows a bottom elevation view of a tethered silicone pad strap assembly of the embodiment of FIG. 28a.

FIG. 28d shows an isometric view of a tethered silicone pad strap lock base of the embodiment of FIG. 28a.

FIG. 28e shows a top elevation view of a tethered silicone pad strap tether of the embodiment of FIG. 28a. The top and bottom are mirrors of each other.

FIG. 28f shows a side elevation view of a tethered silicone pad strap tether of the embodiment of FIG. 28a. The two sides are mirrors of each other.

FIG. 28g shows a front elevation view of a tethered silicone pad strap tether of the embodiment of FIG. 28a.

FIG. 28h shows a back elevation view of a tethered silicone pad strap tether of the embodiment of FIG. 28a.

FIG. 28i shows a top isometric view of a tethered silicon pad strap on a brush of the embodiment of FIG. 28a.

FIG. 29a shows a front elevation view of an embodiment of an LED light or LED-integrated counterweight assembly.

FIG. 29b shows a back elevation view of an LED light or LED-integrated counterweight assembly of the embodiment of FIG. 29a.

FIG. 29c shows a right elevation view of an LED light or LED-integrated counterweight assembly of the embodiment of FIG. 29a. The left elevation view is a mirror of the right.

FIG. 29d shows a top elevation view of an LED light or LED-integrated counterweight assembly of the embodiment of FIG. 29a.

FIG. 29e shows a bottom elevation view of an LED light or LED-integrated counterweight assembly of the embodiment of FIG. 29a.

FIG. 29f shows a right elevation view of an LED light or LED-integrated counterweight assembly on a brush of the embodiment of FIG. 29a.

FIG. 29g shows an isometric view of a counterweight lock mechanism of the embodiment of FIG. 29a.

FIG. 30a shows a side elevation view of a schematic drawing of a representational tool connected to a handle.

FIG. 30b shows a 2-part brush of FIG. 30a.

FIG. 30c shows a right elevation view of a window washer brush connected to a handle of the embodiment of FIG. 30a.

FIG. 30d shows a side elevation view of a window squeegee connected to a handle of the embodiment of FIG. 30a.

FIG. 30e shows a side elevation view of a of a drywall blade, or drywall knife connected to a handle of the embodiment of FIG. 30a.

### DETAILED DESCRIPTION

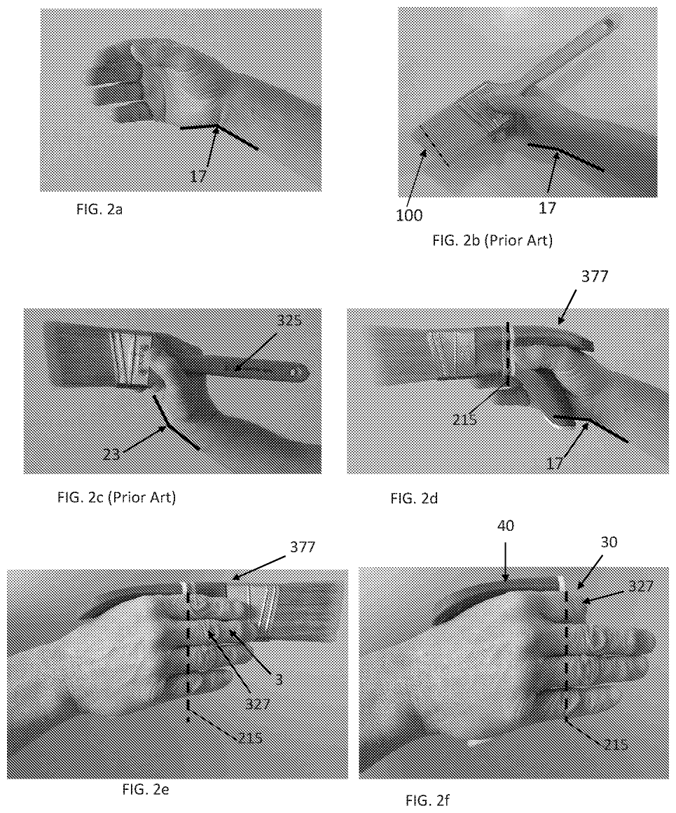

Representative embodiments according to the inventive subject matter are shown in FIGS. 2d-4d and FIGS. 6a-30e, wherein the same or general similar features share common reference numerals. As persons skilled in the art will appreciate, handles according to the inventive subject matter are generally sized and shaped for an intended user's hand and may come in different sizings to accommodate a range of hand sizes. For example, extra small, small, medium, large, extra-large, known sizings as used in the tool or glove trade may be used. Each size range may accommodate a range of hand sizes, e.g., small hands may reflect a range of small hand sizes. The intended user is a human with typical band anatomy and having a hand size that corresponds to a handle corresponding to known hand size or hand size range, e.g., a medium size hand corresponds to a medium size handle.

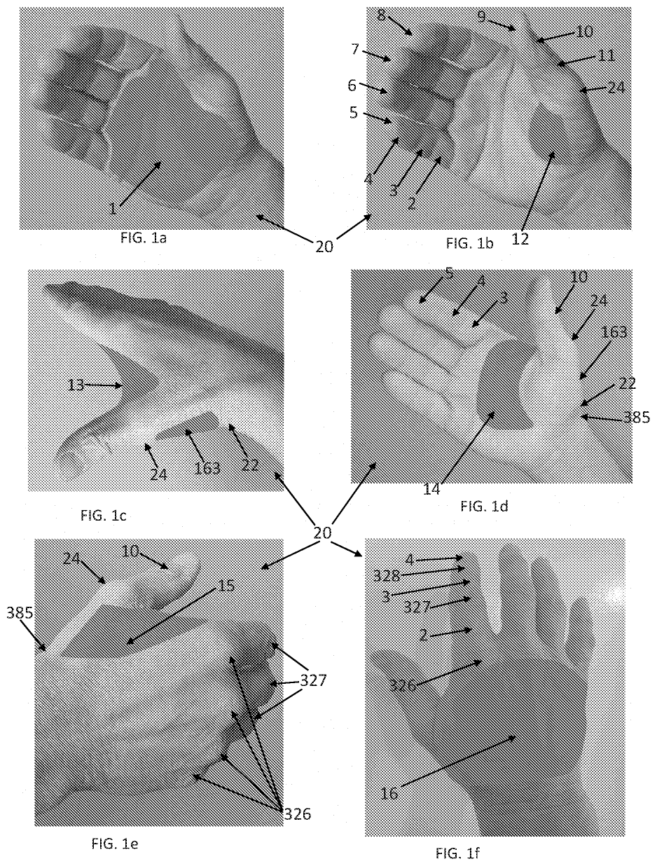

FIGS. 1a-1f show a human right hand (20) and wrist (385), (this was missing the last parenthesis) representing the palm (1), or the palmar side of the hand, and representing the back, referred to as the dorsal side, or metacarpal side of the hand.

Generally, a user's hand includes a palm (1) to which is connected a thumb (9), a forefinger (8), a middle finger (7), a ring finger (6), and a pinky finger (5). A web of muscles connects the base of the thumb and forefinger, which creates a fleshy pad in the form of a thenar webspace (13) on the side of the palm of the user's hand, another fleshy pad in the form of a thenar eminence (12) on the thumb side of the back of the user's hand. the region of flesh between the thumb (9) and forefinger (8) as well as the fleshy pads on either side of the user's hand, are collectively referred to herein as the saddle of the user's hand, indicated generally at (14/15), wherein the front saddle area of the hand is known as the palmar saddle area or region (14), and the back saddle area of the hand is known as the dorsal saddle area (15). Additionally, the back side of the hand below the metacarpophalangeal joints (326), and above the wrist (385), shall be referred to in general as the metacarpal region (16). The fleshy pad on the palmar side of the hand, below the palmar saddle (14), and between the thumb's metacarpophalangeal joint (24) and the wrist (385) shall be known as the thenar eminence (12).

FIG. 1c shows the fleshy area between the thumb (9) and forefinger (8), known as the thenar webspace (13), and the extensor pollicis brevis tendon area (163), which is laterally oriented between the thenar eminence (12), and metacarpal region of the back of the hand (16) and vertically oriented from the thumb's metacarpophalangeal (24), carpometacarpal joint (22) is highlighted.

A healthy, natural body position is commonly known as a neutral position. The advantages of the design of the handle (40) and complete brush (36/377) of the inventive subject matter and the angle in relation to the neutral wrist position, shape and angle of the human hand (20) and alignment to the work surface over a conventional paintbrush (325) design are numerous. A neutral wrist bend (this is shown in FIGS. 2a, 2b, 2d) is maintained while using the inventive subject matter, while the wrist (385) and fingers are forced to be manipulated into unnatural and unhealthy positions by the design of the conventional paintbrush (325).

The joint at the base of the fingers, above the metacarpal region (16), is known as the metacarpophalangeal joint (326). The first joint distally from the metacarpophalangeal joint (326) is known as the proximal interphalangeal joint (327). The joint distally from the proximal interphalangeal joint (327) is known as the distal interphalangeal joint (328).

“Neutral posture [or position] refers to the resting position of each joint—the position in which there is the least tension or pressure on nerves, tendons, muscles and bones.” (Source: https://health.uconn_edu/occupational-environmental/wp-content/uploads/sites/25/2016/01/workstation_adjustment.pdf)

The conventional paintbrush design forces the user into what is commonly referred to as a pinch grip, shown in FIGS. 2b and 2c. Most of us have experienced “writer's cramp” from holding a pen or pencil for long periods of time. The grip used to hold a pen or pencil is also a pinch grip. The pinch grip is known to have negative health consequences including tendonitis arthritis and Carpal Tunnel Syndrome. The pinch grip causes a group of muscles to tense from the fingers all the way into the neck. That muscle group triggered by the pinch grip is exerting effort and fatiguing the entire time the user is painting.

“Exposure to stressful hand and wrist activities is determined by the: 1) time spent in awkward postures (wrist is bent >20°) and 2) repetitive nature of the task.

These are signs of exposure to stressful hand and wrist activities:
Time spent with the wrist bent more than 20° in any direction for >⅓ of the cycle time.
Repetition as defined by either:
   Use of the hand, wrist, or finger with a cycle time of <30 seconds.
   More than half of the cycle time is spent performing similar hand or wrist motions.
Hand force:
   Using a pinch grip in which the thumb and fingertip are <5 cm apart to hold something for >⅓ of the cycle time.”
      (Source: www.cpwrconstructionsolutions.org)

In addition, with a conventional paintbrush design the hand is held directly in line with the brush's bristles (also known as filament) which interferes with the user's line of sight. To compensate, users often: tilt their neck, back or wrist to improve visibility to the work surface.

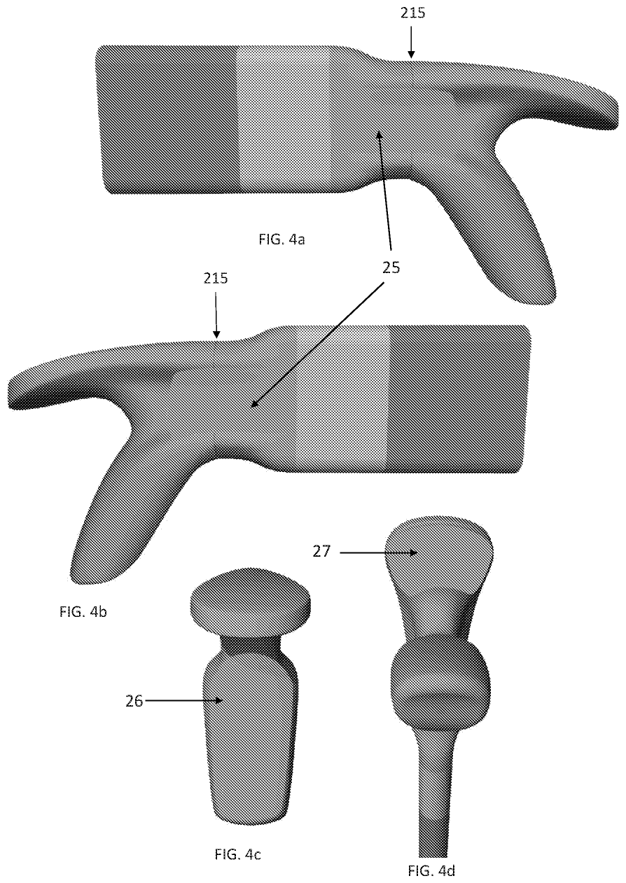

Do-it-yourself (DIY) painters often tilt their neck or back to compensate for the hand's interference with line of sight. Tilting the neck or back for prolonged periods can cause cramping, stiffness, pain, and excessive fatigue and in the long-term has even more dire consequences. Professional painters typically tilt their wrist up to improve visibility. Tilting the wrist for long periods of time puts pressure on the Carpal Tunnel and increases the potential of repetitive stress injury. As stated previously, stressful wrist activity is time spent with the wrist bent more than 20 degrees. The user's wrist in FIG. 4f is tilted at 30 degrees and which is not uncommon for painters as stated previously, has been determined to be stressful and is unnecessary.

This, in combination with the pinch grip, is a major cause of Carpal Tunnel in the painting industry and a source of pain for the average do-it-yourself (DIY) painter.

FIGS. 2e-2f show both the design intention and rationale for the designation of the juncture (215) of the rotational axis of the inventive subject matter. In FIG. 2e, a division, or juncture (29) between the handle (40) and brush-head cartridge (39/376) is shown. This juncture (215) is positioned to allow a user with small hands to bend their forefinger (8) 90 degrees (30) at the proximal interphalangeal joint (327), so the middle phalanx (3) of the user's finger can rest on the handle face (35). A juncture beyond the proximal interphalangeal joint (327) would not allow a full, controlled rotation of the brush-head cartridge (39/376), a juncture closer proximally to the metacarpophalangeal joints (326) would force the fingers into unnatural and uncomfortable positions during the rotational process.

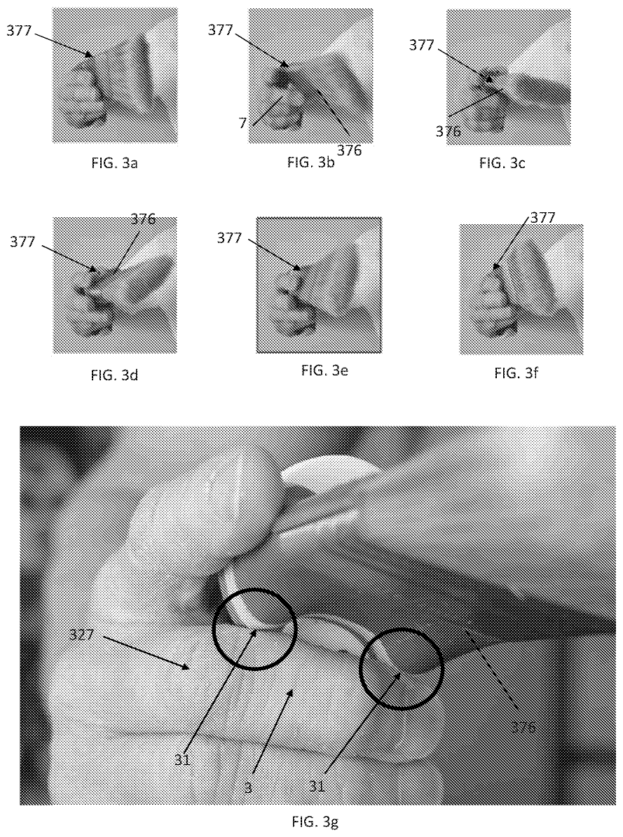

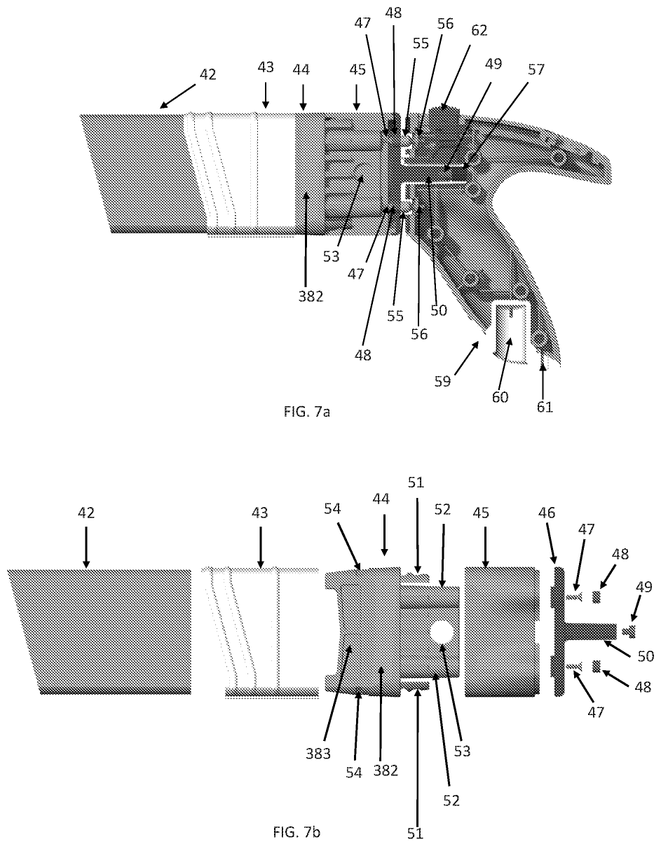

FIGS. 3a-3f show front left isometric views of a person with a complete 2-part brush (377) of the inventive subject matter rotating the distally oriented brush-head cartridge (376) using the middle finger (7) and forefinger (8) only. The Figures show different possible rotational positions of the brush which can vary by 10, 20, 30, 40, 50, 60, 70, 80, 90, 120, 180, 270, 360 or any other desired number of degrees from a selected origin, with various being possible in discrete increments or continuously. A user may choose to use other fingers in rotating the brush-head cartridge (39/376). This rotation can be done with great ease, and virtually no resistance. In one possible embodiment (e.g., FIGS. 7a-7b), a handle shaft receiver magnet (57) connects magnetically to either a steel plug (49) or magnet (63) at the proximal end of the extension cartridge face shaft (50). A slight separation exists between the handle shaft receiver magnet (57) and the extension cartridge magnet (63), or plug (49), providing free rotation, without interference of any mechanical connection. No internal gears, ratchets, or other stop mechanisms are required, meaning no perceivable resistance is felt during rotation.

Some embodiments of the inventive subject matter contemplate a handle is designed for use with a complementary cartridge for supporting a tool. The handle includes a downwardly, vertically extending proximal handle portion for receiving the palmar saddle of a user's hand. Extending from the vertical handle portion is a horizontally extending distal handle portion for receiving a cartridge. The distal handle portion has a face with a recess for receiving a shaft of the cartridge, the shaft and recess being alignable along the longitudinal axis of the distal handle. The recess is configured so that the shaft is rotatable in the recess. The face has one or more engagement elements that engage with complementary engagement elements on an opposing surface of the cartridge so that the cartridge may be rotated around the axis at least 90 degrees from the first position to a second position. The complementary engagement elements are engageable in a plurality of positions to set the position of the cartridge relative to the handle. The handle is configured so that when the user is gripping the handle with the Palmar saddle against the palmar saddle rest area (26)

The face of the handle may be configured to be proximal to the intended user's first knuckle, or proximal interphalangeal joint (327) when the user grips the and handle. The handle (40) may have one or more contoured areas that includes, on opposing lateral sides of the body, a pair of upper and lower ridges flaring from the body and extending longitudinally along each of the opposing sides of the body. Each pair of ridges may define respective forefinger and thumb rest areas, and each pair of ridges may be configured to abuttingly engage the respective forefinger or thumb placed in the rest area during use; and/or (2) a hand rest area having a bottom-facing surface disposed on the body above the thumb and forefinger areas and above the hand grip, the bottom-facing surface extending longitudinally, rearwardly from the body beyond the forefinger and thumb rest areas (25). In some embodiments such a bottom surface may extend laterally wider than the body so as to be configured to cover the dorsal saddle (15) of the intended user. While in other embodiments, the bottom surface may extend laterally wider than the body so as to be configured to cover the thenar webspace.

The handle may have a bottom-facing hand rest surface that receives the user's dorsal saddle (15), thereby allowing the user's arm to carry the weight of the handle, and allowing the user's fingers to be relieved of gripping the handle. The handle may have finger and thumb rest areas (25) that are respectively configured with outwardly facing concave surfaces.

When the brush-head cartridge (39/376) is in its vertical orientation, the opposing face magnets (55) and extension cartridge face magnets (48) secure the brush head cartridge (39/376) from involuntarily rotation, without undue pressure, beyond the general forces of painting. The magnetic force can be easily overcome by pushing either the upper or lower finger rest areas (25) of the brush-head cartridge (39/376) the fingers to engage the rotational process.

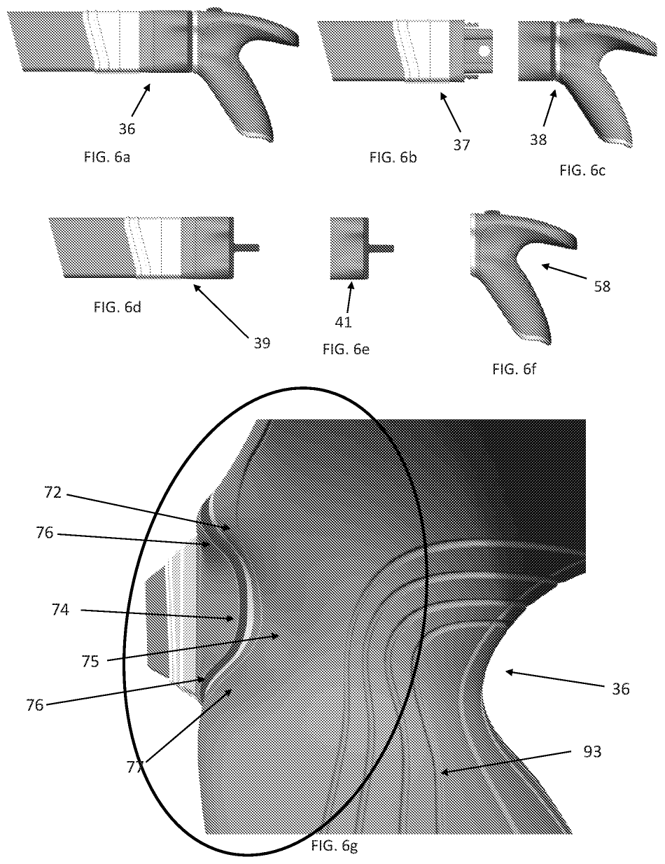

Rotation of the brush-head cartridge (39/376) may be achieved by moving the middle finger (7) laterally from its proximal interphalangeal joint, or first knuckle so as to contact the surface of the cartridge lower finger and thumb rest areas (25) with the end of the middle finger (4), and continuing to bend the middle finger (7) across the lower half of the face of the handle until the middle finger abuttingly rests on the handle face (35) The natural position of the user's middle finger from that action places it abuttingly against the two mirrored outward-most surface regions of the finger and thumb rest areas (25) of that side of the cartridge, creating a natural stop or support position for the cartridge (39), preventing the cartridge (39) from inadvertent and unwanted rotation. By use of only the middle finger (7) and forefinger (8), the brush-head cartridge (39/376) can be rotated either clockwise or counterclockwise, easily changing orientation. This is relevant for practical purposes for a painter, a drywaller, a window washer and so on. In the US, a vast majority of paintbrushes sold are angled brushes, as seen, for example, in FIG. 6a. Angled brushes (100) are designed to have the shorter end of the bristles as the leading edge and are considered unidirectional. This means for best results it is necessary to frequently change the angle of the brush-head to keep a leading edge. This may be done by either manipulating the body, which can be harmful, or by rotating, or flipping, the brush. By allowing the body to maintain its natural, neutral positions, by the design of the handle (40) of the inventive subject matter, and adding the ability to simply, efficiently, and effortlessly rotating the brush-head cartridge (39/376), the inventive subject matter provides a significant advancement in paint applicators, and other tool uses.

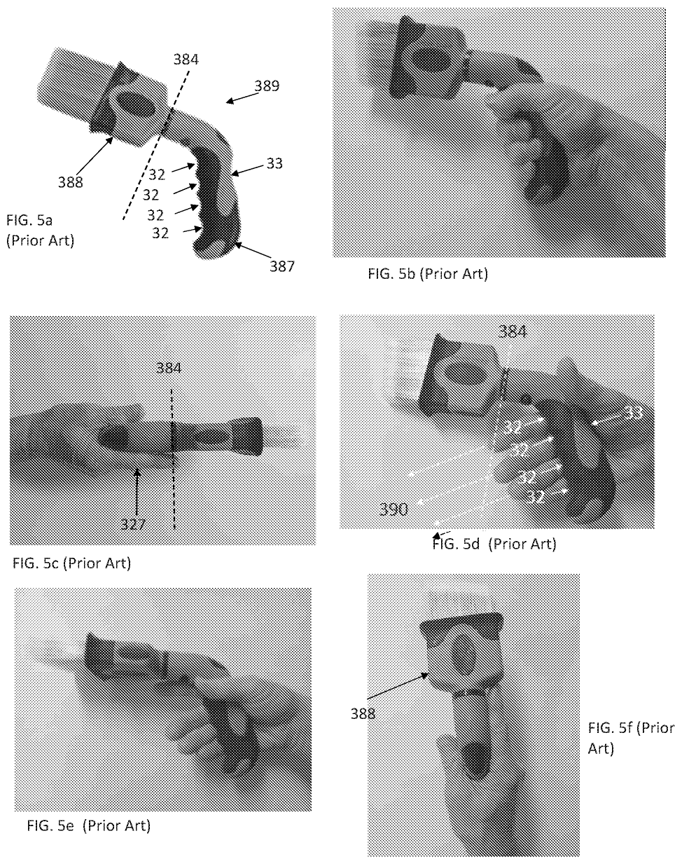

FIGS. 5a-5f show prior art, its design intention and practical use, the orientation of the handle (387) and brush head cartridge (388), and the orientation and position of the juncture of the handle and brush head cartridge, in relation to the fingers required for rotation with one hand. The prior art (389) was never designed or intended to be rotated with the same hand used to hold it. It was designed and intended to be rotated with the free hand. A user of the prior art (389) with a small to medium size hand and fingers is likely unable to rotate the brush head cartridge (388) at all, and certainly with no degree of control. Additionally, the ratcheting spring-loaded internal mechanism of the prior art, designed for precise angle adjustment and locking in each position, works against the user attempting to rotate it, by offering resistance that the finger cannot overcome. The spring strength is intended to ensure the brush-head cartridge (388) will not accidentally rotate, therefore it must be strong enough to fight the forces of leverage provided while painting. The prior art (389) must lock in position because there is no other means to secure the rotational angle change without a locking mechanism. Additionally, the angle of the distally protruding brush-head cartridge (384) in relation to the angle of the fingers (384/390), make any rotation of the brush-head cartridge impractical, if not impossible. FIGS. 5e-5f clearly show that the fingers are unable to sufficiently engage the brush head cartridge when the cartridge is in a horizontal orientation, making rotating with a single hand impossible. Unlike the handle design of the inventive subject matter, where the fingers are not required to hold the handle (387), the user of the prior art (389) must hold the handle (387) at all times. The hand of the user of the prior art (389) would suffer tremendous fatigue attempting to hold and manipulate their fingers into awkward and potentially injury-causing positions to attempt to rotate the brush-head cartridge (388) with a single hand.

When referring herein to a handle (40), it is not specifically referring to any particular handle embodiment, rather all possible handle embodiments of the inventive subject matter (58/68/69/70). When referring to a complete brush (36) of the inventive subject matter herein, unless specified as a complete 2-part brush (377), or as a complete 3-part brush (36), it is not specifically referring to any particular brush-head cartridge embodiment of the inventive subject matter, rather any complete brush. When referring to a brush head cartridge (41) of the subject matter, in general terms, without reference to a 1-part brush-head cartridge (376) (of a 2-part brush (377)), or 2-part brush-head cartridge (39)) of a 3-part brush (36)), the terms may describe any embodiment making up a brush-head cartridge of the inventive subject matter.

When referring to a screw, or other fastener herein, we are general terms of the assembly of the inventive subject matter, wherein reference to using a screw as a fastener, can reasonably be assumed to be any fastener, a bolt, a rivet, and so on.

FIGS. 6a-6f show a complete 3-part brush assembly (36), sequentially exploded into individual sections and finally in FIGS. 7a-7b shown exploded into individual component parts, which are show individually, in greater detail, within the figures.

A complete 3-part brush assembly (36), as its name suggests, has three assembled bodies, the handle (40), which is universal to both a complete 3-part brush assembly (36) and 2-part brush assembly (377), an extension cartridge (41), which is also universal to a 2-part brush (377) and a 3-part brush (36), a brush insert cartridge (37) also referred to as a refill cartridge (37), which is for a 2-part brush head cartridge (39) and 3-part brush (36). The extension cartridge (41) plus brush insert cartridge (37) make up a 2-part brush-head cartridge (39). The 3-part brush assembly (36) is sold initially as a complete assembly. After the initial purchase, the user buys only the brush insert cartridge (37). This has many advantages to all parties, the retailer, the consumer, and the manufacturer. The cost to produce a brush insert cartridge (37) is much lower than the cost to produce the entire brush. Less than that of a 1-part brush-head cartridge (376) of a 2-part brush assembly (377). The size of the brush insert cartridge is about half that of a conventional paintbrush (325), and one-sixth that of a complete 3-part brush assembly. It also weighs less than both. This means less space taken on the retailer's shelf, meaning more profit per square foot, more product per carton and at a lower weight, saving on fuel and transportation costs, a lower cost meaning a lower retail price for the consumer, and less material going into a landfill. The plastic used can be made from biodegradable materials, such as bamboo and corn husks, which gives a smaller carbon footprint.

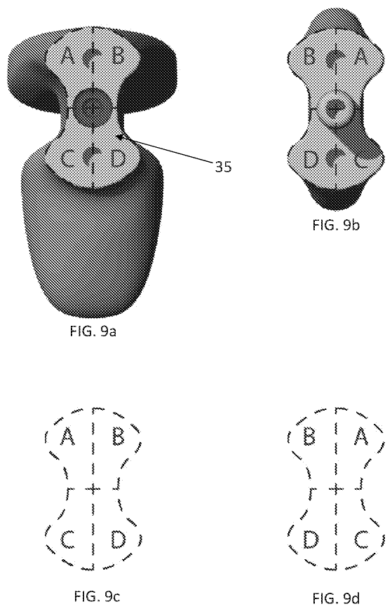

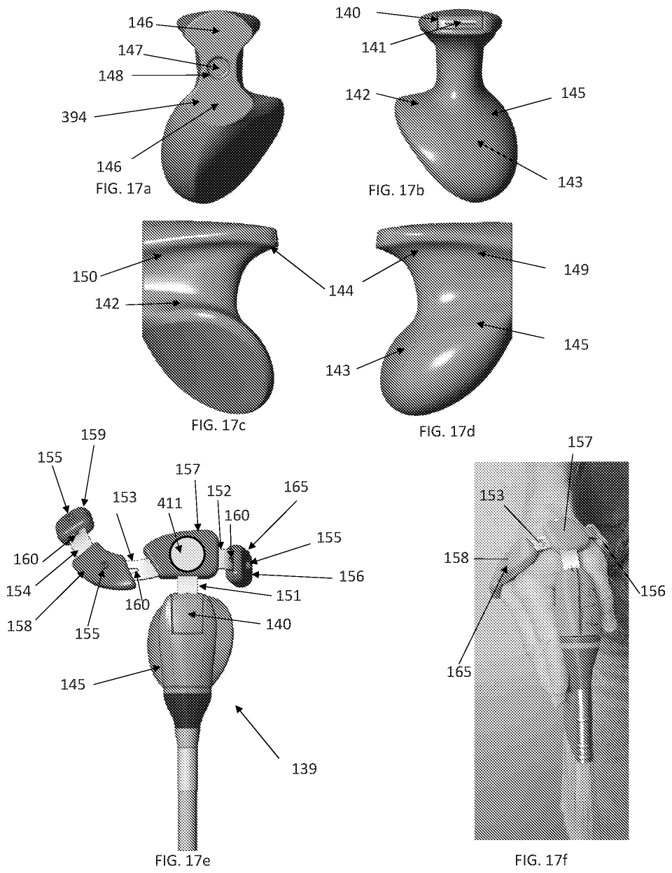

Both complete 3-part brush assemblies (36) and complete 2-part brush assemblies (377) have a curve-continuous surface (74/75, 77/76, 72/76), shown in FIG. 6g, extending distally from the handle with finger and thumb rest areas (25) appending distally from the palmar rest area (26), and a hand rest area (27) where the handle rests on the dorsal saddle of the hand. All handles, except the non-symmetrical handle (70) FIG. 17a, are symmetrical for both right and left-handed users. All handles have a rear-facing terminating symmetrically mirrored face FIGS. 9a, 9c, which allow each to use the same extension cartridge (41) and brush insert cartridge (37), along with all accessory attachments. Each handle includes a 4-way keylock feature (62), which locks the brush-head cartridge (39) in each vertical and horizontal position, a top locking accessory mounting port (83), which can receive multiple accessories, and handle plug accessory receiving channel (60) to connect other accessories.

The illustrated embodiments disclosed herein are shown and discussed with respect to a paintbrush, as a non-limiting example of a hand tool, for the sake of ease of explanation. However, the principles of construction and operation explained and illustrated herein may be adapted to a wide range of hand tools, including screwdrivers, scrapers, travels, and other surface preparation tools, gardening tools, joinery and kitchen utensils, and so forth, without departing from the spirit and scope of this disclosure, which is intended to encompass such variations. Each embodiment disclosed herein can be assumed to be adapted to all handles of the inventive subject matter, not specifically to the handle embodiment described or illustrated.

The inventive subject matter will have available multiple handles that provide specific utility and features, yet each can use all accessories, and share the same brush insert cartridges (37). By sharing the same brush insert cartridge (37), a retailer need only carry 1 handle of each type, and a shared assortment of brush insert cartridges (37), Saving on inventory costs of multiple brushes, and shelf space which is coveted by retailers. Sharing brush insert cartridges (37) with all handles (40) is also advantageous to the user, who can have the advantage of the utility of each handle (40), and all accessories, at a low cost.

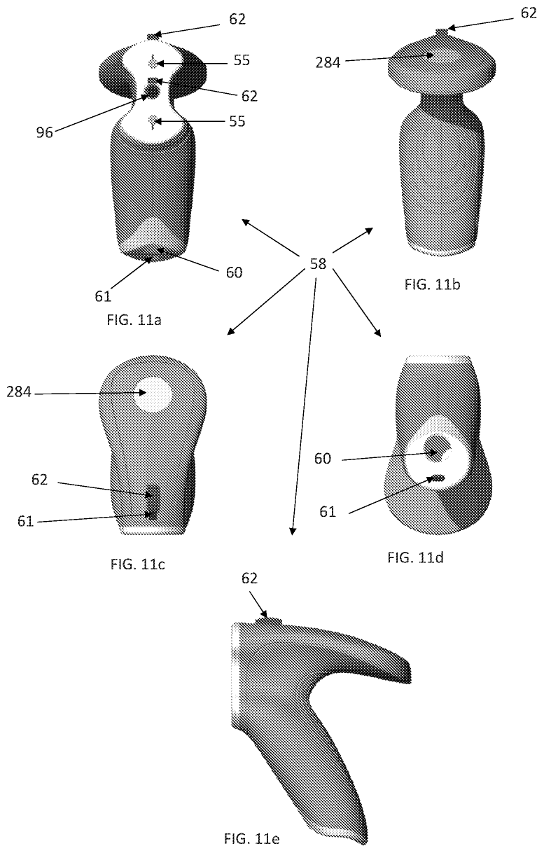

A fixed-position handle (58) being of solid plastic, or other structural materials. The components and assemblies of the fixed position handle (58) are shown are assemblies and individually in FIGS. 11a-13g.

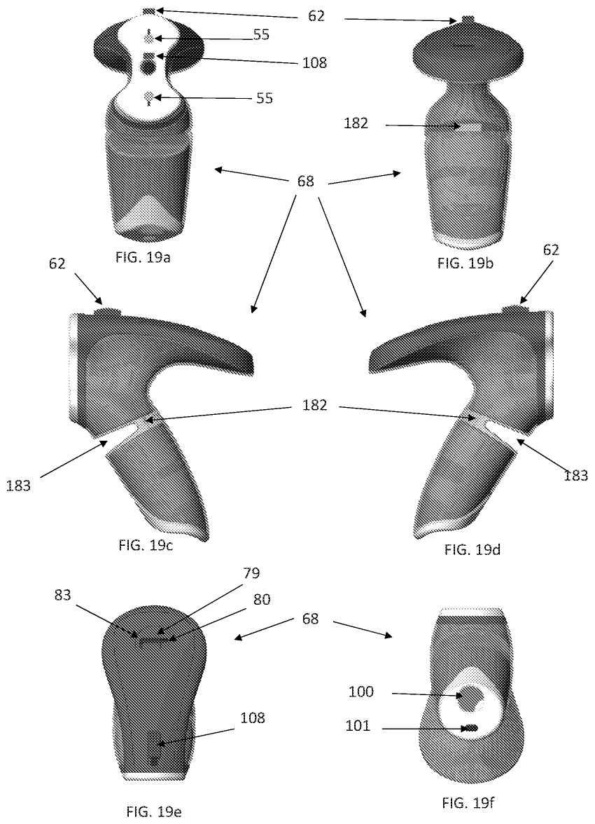

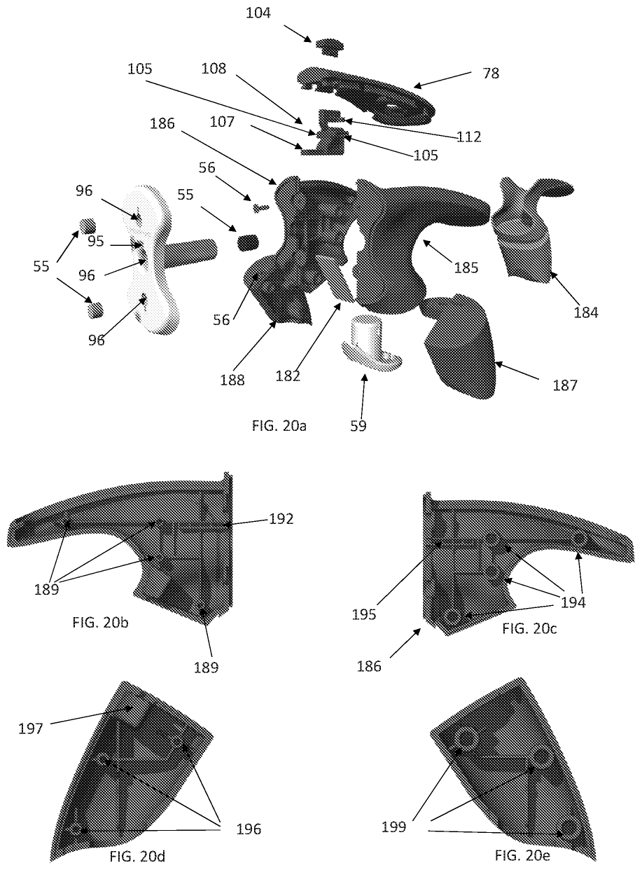

The thickness of a user's hand can vary greatly. To accommodate differing hand thicknesses, an articulating handle (68) can be made available that adjusts its palm area upward or downward by bending and internal aluminum bar (182), which is connected to top and bottom plastic housings. An example of an articulating handle (68) is shown on FIGS. 19a-19f. The aluminum bar (182) can be either over-molded or inserted into the top and bottom parts. In this example, we will discuss it being over-molded. The aluminum bar (182) is over-molded into a boss (191) on the right top chassis (185), and a boss (197) on the right bottom chassis (187). The top and bottom sections, along with the aluminum bar (182) are over-molded by and soft elastomer compound (184), allowing the handle flex and change the opening size between the hand rest (27) and the palmar saddle rest area (26). This articulating handle (68) shares much of its shape to the fixed position handle (40), and shares some of the same component parts: handle top (78), handle face (98), and handle plug (99). The components and assemblies of the articulating handle (68) are shown are assemblies and individually in FIGS. 19a-20e, with the exception of the handle top (78), handle face (35) and handle plug (78), which are common parts with the fixed-position handle (58).

The flange handle (69) has a forward-facing, distally-protruding flange handle area (90), designed for side-to-side movement of generally larger surfaces. The flange shape (90) of the lower body provides additional leverage from the user's palm (1) and lower fingers. It shares the same accessories, extension cartridge (41), and brush insert cartridge (37) as the other handles.

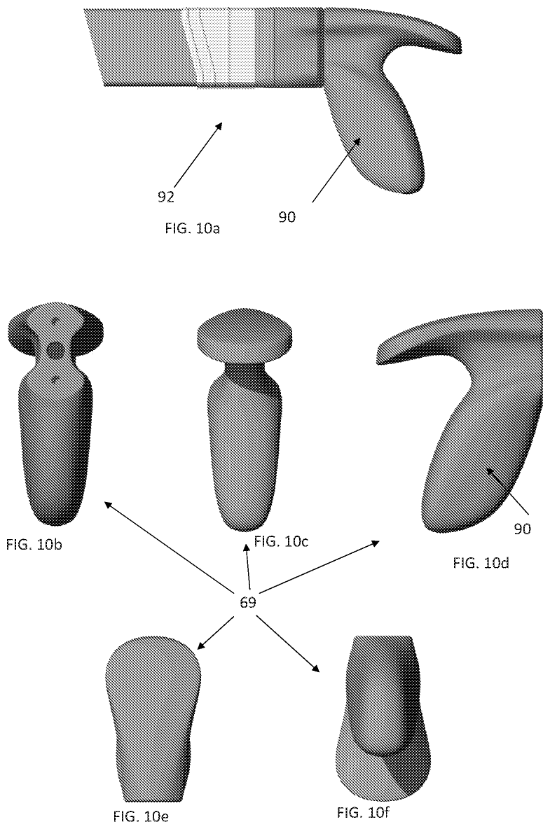

FIG. 10a shows a right elevation view of a 3-part flange handle brush (92) with a distally broad-based flange handle (69) base of the inventive subject matter, with a the flange area (90) highlighted. The flange handle shares all other characteristics of the fixed-position handle (58), although the particular embodiment shown focuses only on the form and not features of the handle. It can be assumed that a lock feature (62), bottom handle plug (59), and handle face (35) would be included in an additional embodiment.

Additionally, a non-symmetrical handle (70), shown in a right-handed version, will be available, which matches each region of the hand with a specific rest area. A right-handed version and left-handed version can be made available. The non-symmetrical handle (70) shares the same accessories, extension cartridge (41), and brush insert cartridge (37) as the other handles. All handles may come in different sizes and shapes to accommodate a range of hand sizes and differing functionality.

All handles share the same extension cartridge (41) which means they all can accept the same brush insert cartridge (37). Brush insert cartridges will be available in multiple bristle/filament type, and size and shape. Brush-heads with natural hair are generally described as having bristles, where brush-heads with synthetic hair fibers are generally described as having filaments. Different countries around the world use different types of filaments/bristles as well as different shaped ferrules and brush-heads.

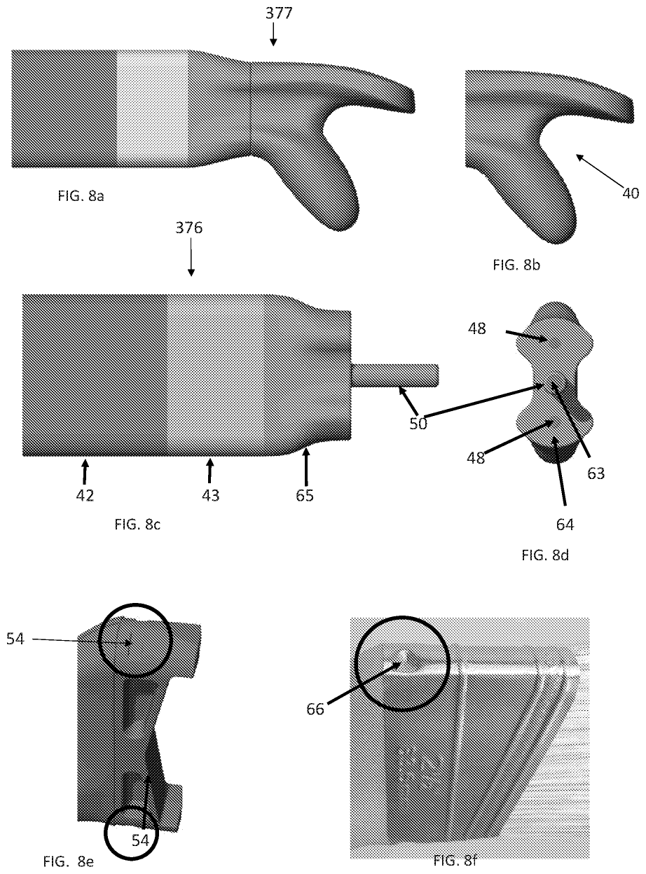

FIGS. 8f-8g show isometric views of the crimped connection elements of the brush insert and ferrule (43). Each brush insert has 4 debossed crimping locations (54), where the ferrule (43) is crimped onto the brush insert (44) of a 2-part brush head cartridge (39), or extension cartridge (65) of a 1-part brush-head cartridge (376).

FIGS. 9a-9d show the handle (40) and cartridge (41) faces. Both the forward-facing face of the handle and rearward-facing face of the cartridge are mirrored both vertically and horizontally by planes crossing at the center of the handle receiver channel and cartridge post. The handle and cartridge faces are mirror of each other, to keep the shapes aligned when rotated 180 degrees from an initial vertical orientation.

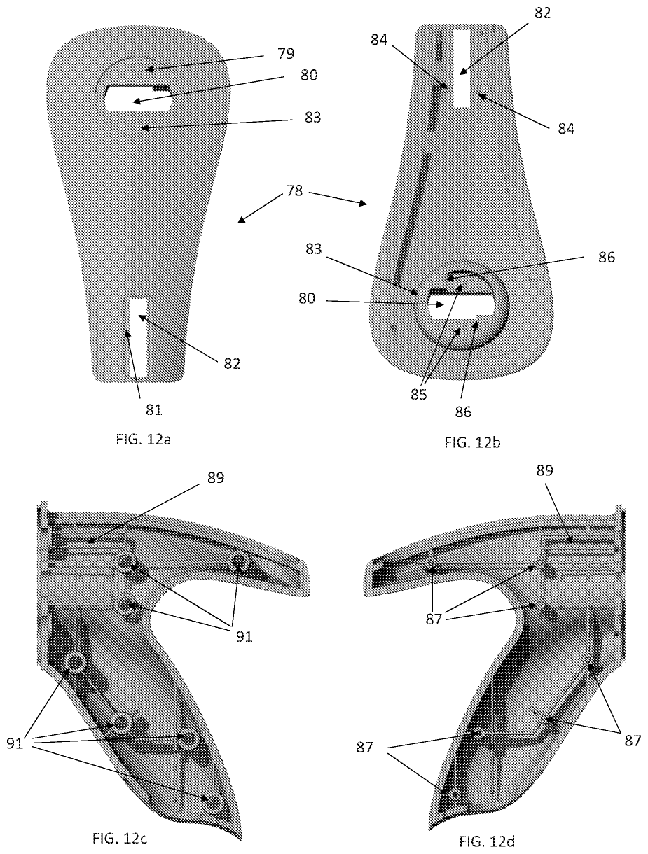

FIGS. 12a-12b show the handle top (78), which is a component of all but the non-symmetrical handle (70), has front lock pass-through where the 4-way lock assembly base (108) is fed upward with the lock shaft (107) facing forward where its mating snap receivers (111) connect with the lock push button snaps (110), which mate the two parts together to become a lock assembly (62).

The handle top (78) and non-symmetrical handle central pad (157) have locking accessory mount port (83/411), which accepts accessories such as a counterweight (285) with a quarter turn twist-lock. The locking accessory port (83) includes an embossed spherical secure hold feature (85) which receives a corresponding debossed spherical feature on the accessory keylock of accessories, thus holding the accessory in place. The accessory keylock feature is inserted into the lock mechanism pass-through (82), then with a quarter turn, the accessory keylock feature's leading edge contacts the handle top lock mechanism position stop (84) assuring consistent alignment of the accessory.

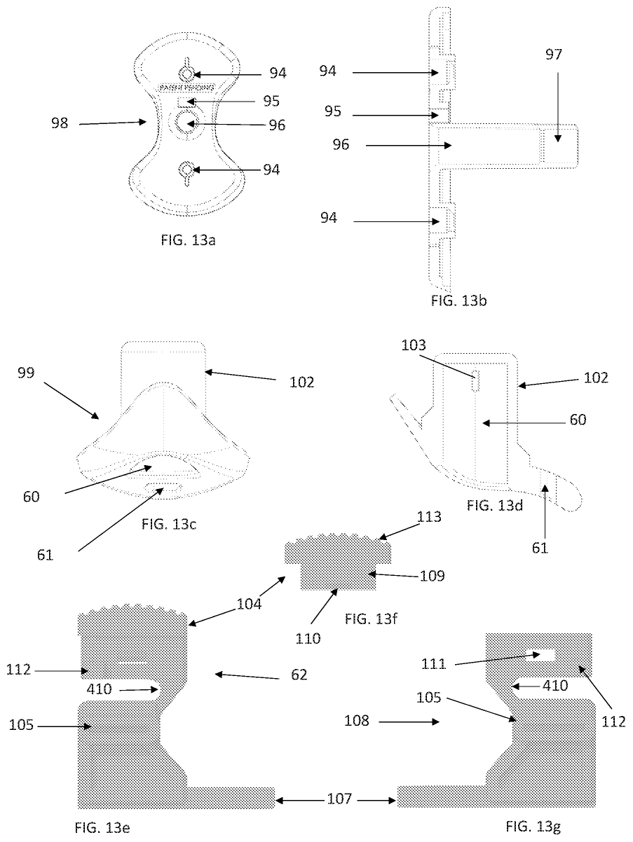

FIGS. 13a-13b show the handle face (35). The handle face (35) connects to both the fixed position handle (58) and articulating handle (68), via screws (47) inserted rearwardly from within the handle face vertical magnet bosses (94), on both top and bottom. The face magnets (55) are glued and/or press fit. At the proximal end of the reward-facing shaft receiver channel (95) is a magnet boss (97) where a magnet (57) is glued and/or press fit. This magnet creates a magnetic with the magnet (57) or steel plug (49) of the extension cartridge (41), without interference, securing it in place, but providing for resistant-free rotation of the extension cartridge. The handle face (35) also has a lock shaft pass-through (95) which the lock shaft (107) passes through to enter the extension cartridge lock pass-through (117). The outer profile of the handle face (35) is a mirror of the extension cartridge (41) and each pulls tangency from that shape to create a curve-continuous surface between the two parts as shown in FIG. 6g.

FIGS. 13c-13d show the handle plug (59). The handle plug (59) has a snap receiver (103) that connects to snaps on both the fixed handle (40) and articulating handle (68) for final assembly. The plug has an accessory receiver channel (60) which allows it to receive multiple accessories and attachments, including straps, a rest stand for the handle, a stand shaft which could be mounted to a ladder with a clamp, or to the edge of a paint pail, and other accessories. The plug has a drain hole (61) to release trapped water in the handle.

When using a telescoping extension (266), roller attachment (205), or any time the user wants the orientation of the tool head to be in a fixed position for an extended period of time, the inventive subject matter may include a 4-way lock feature, allowing for a secure hold in each vertical and horizontal 90-degree position.

FIGS. 13e-13g show the 4-way handle lock assembly (62) and parts. The lock (62) has a push-button (104) which is depressed, using a cantilever (410) action, and moved distally from the handle, when engaging the lock (62), to allow the lock stop posts (112) to pass under the handle lock position stop (380), as the lock slide rails (105) slide in the handle lock slide cavities (89) on a fixed-position handle (58), and top right (192) and top left (195) channels on an articulating handle (68), and the lock shaft (107) travels distally from the handle, in the slide cavities (89/192/195), through the handle face lock shaft pass-through (95) until it passes the lock stop posts (112) passing through one of four extension cartridge face lock shaft pass-throughs (117), engaging the lock. To disengage the lock, the push button (104) is depressed and moved proximally until the lock slide rails (105) reach the proximal end of their respective handle slide rail cavities.

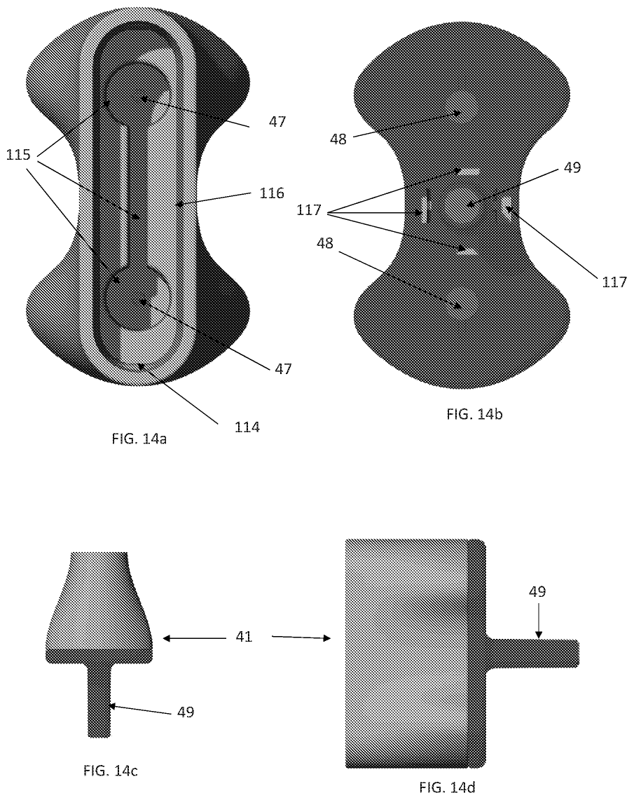

FIGS. 14a-14d show an extension cartridge, (41) its components and assembly. The extension cartridge (41) is a common component for all handles (40) of the inventive subject matter. It receives multiple attachments, most commonly, a brush insert cartridge (37). The extension cartridge (41) has to main parts, the cartridge face (64) and the extension cartridge transition (45). The extension cartridge face (64) connects to the extension cartridge transition (45) via screws (47) inserted distally from within the magnet bosses (120), on both top and bottom. The face magnets (48) are glued and/or press fit. At the proximal end of the reward-facing shaft (49) is a magnet/steel plug boss (67) where a magnet (57) or steel plug (67) is glued and/or press fit. This creates a magnetic with the magnet of the handle face (35), without interference, securing it in place, but providing for resistant-free rotation of the extension cartridge. The extension cartridge (41) also has four lock shaft pass-throughs (117) which the lock shaft (107) passes through to engage the 4-way lock (62). The outer profile of the extension cartridge (41) is a mirror of the handle face (35) and each pulls tangency from that shape to create a curve-continuous surface between the two parts as shown in FIG. 6g.

The extension cartridge has shaft receiver channels (115) and main receiver channel to receive the insert portion (44) of the brush insert cartridge (39), and a transition sphere bump (114) which engages with a spherical deboss (51) on the insert cartridge (37) to secure the brush insert cartridge (44) in the extension cartridge (41).

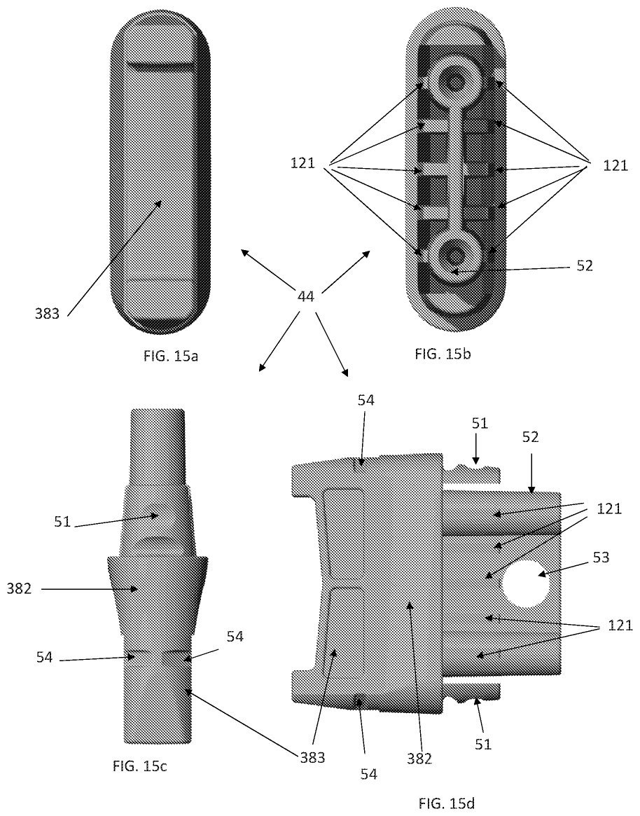

FIGS. 15a-15d show a brush insert (44) for a complete 3-part brush assembly (36). The brush insert (44) has a brush insert hang hole (52) which can be used to hang the brush insert cartridge (39), or brush-head insert cartridge (37) for drying or storage, or for hanging on a peg/hook in a retail store.

The brush insert (44) has 4 debossed crimping locations (54). It connects permanently to a ferrule with bristles/filaments (42) by inserting the ferrule proximally into the 2-part brush-head cartridge ferrule insert portion (383) of the brush insert (44), then crimping the ferrule into each of the four brush insert crimping debosses (54), as shown in FIGS. 19a-19c. The new combination of brush insert (44), plus ferrule with filament/bristles (71) is called a brush insert cartridge (37)

The brush insert cartridge (37) is inserted proximally into the extension cartridge (41) with its rearward-facing alignment shaft (50) mating to the transition shaft receiver (115) within the transition receiver channel (116) with the insert alignment ribs (121) of the brush insert cartridge (44) mating to the interior wall of the transition receiver channel (116). The brush insert cartridge. The brush insert cartridge (44) has a spherical deboss (51), which mates to a spherical embossed (114) feature on the interior wall of the transition receiver channel (116), which holds the brush insert cartridge (44) in place. The combination of the brush insert cartridge (37) and extension cartridge (41) are called a 2-part brush-head cartridge (39).

There are many instances where painting in a vertical orientation is most or all of a particular painting job, such as vertical siding, fencing, and decking. Additionally, in Europe, the Middle East, Africa and Latin America, a vast majority of paint brush-heads have square, or flat brush-heads (134), not angled brush-heads (100), which are more common in the United States and Canada. Painting with a vertical motion of the arm creates strain and fatigue in the shoulder and places additional leverage on the brush head, creating additional tension in the fingers, hand, arm, and shoulder of the user. Painting in a vertical motion with and angled brush head (100) increases the tension in the fingers, hand, arm, and shoulder of the user, due to the forces created by the angled and of the brush head, therefore the vertical application extension (126) is intended to receive a flat brush-head (134) type brush-head insert cartridge (37). This vertical motion, when using a standard brush head cartridge (39) of the inventive subject matter, forces the user to maintain a bending position of the middle finger (7) to stabilize the brush head cartridge (41). This causes additional strain and fatigue in the fingers and hand. Additionally, when a standard brush-head cartridge (41) of the inventive subject matter is in a horizontal orientation, visibility to the bristles/filament (42) at the working surface is lessened. To overcome the forces and associated leverage with a vertical painting motion, a specialized extension cartridge was developed, known as known as a vertical application extension cartridge (126).

The vertical application extension cartridge (126) provides greater stability, reduces fatigue in the fingers, hand, arm, and shoulder, and improves visibility to the work surface. Used in combination with the lock feature (62) of the inventive subject matter, the vertical application extension cartridge (126) enhances the painting experience, reduces stress to the user, reduces the potential for injury to the fingers, hand, arm, and shoulder of the user, and ultimately, provides better results.

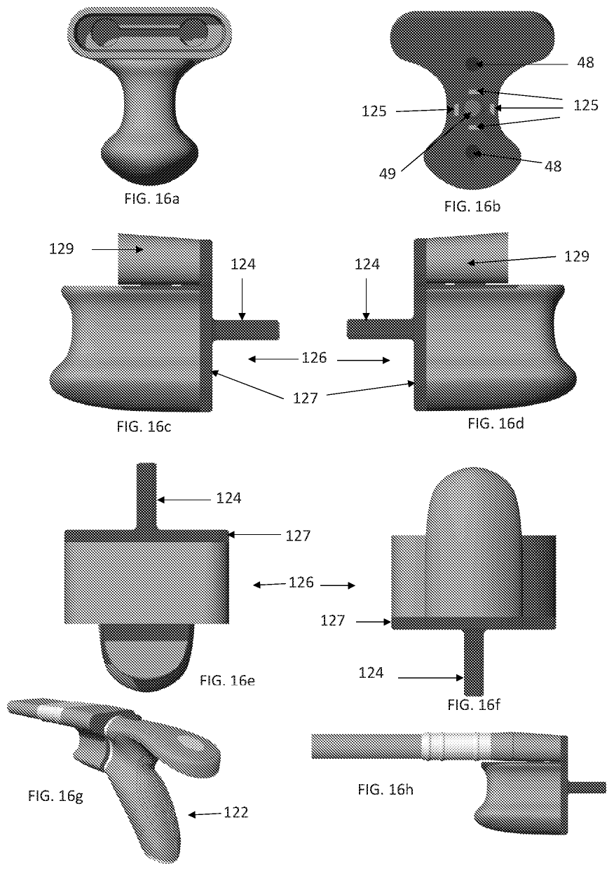

FIGS. 16a-16h Show the vertical application system, its assemblies and components in more detail. The vertical application brush head cartridge (122) is made-up of three main components, the vertical application transition (128), the vertical application extension cartridge face (127), and the vertical application brush cartridge receiver, or vertical application receiver (129).

The vertical application brush cartridge receiver (129) is assembled in a horizontal orientation on top of the vertical application transition (128), distally from the vertical application extension cartridge face (127). The vertical application extension cartridge face (127) connects to the vertical extension cartridge transition (128) on the bottom and vertical application brush cartridge receiver (129) on top via screws (47) inserted distally from within the magnet bosses (137), on both top and bottom, passing through the vertical application face magnets bosses (137) into a top screw boss (131) and bottom screw boss 132 of the vertical application transition (128) where the three parts become secured. The face magnets (48) are glued and/or press fit. At the proximal end of the reward-facing shaft (124) is a magnet/steel plug boss (391) where a magnet (57) or steel plug (67) is glued and/or press fit. This creates a magnetic with the magnet of the handle face (35), without interference, securing it in place, but providing for resistant-free rotation of the extension cartridge. The vertical application extension cartridge (126) also has four lock shaft pass-throughs (125) which the lock shaft (107) passes through to engage the 4-way lock.

The face of the vertical application extension cartridge face (127) blends with the curve of an extension cartridge face (392), creating a curve-continuous surface between the handle (40) and the vertical application brush-head cartridge (123).

With a vertical application brush-heard cartridge (123) inserted in a handle (40), resting on the user's dorsal saddle (15) and in the palmar saddle of the hand (14), in the hand rest area (27), and the palmar saddle rest area (26) of the handle (40), respectively, the user can rotate the cartridge (123) using the middle finger (7) and forefinger (8) only. A user may choose to use other fingers in rotating the brush-head cartridge (123). This rotation can be done with great ease, and virtually no resistance. The handle shaft receiver magnet (57) connects magnetically to either a steel plug (49) or magnet (63) at the proximal end of the extension cartridge face shaft (50). A slight separation exists between the handle shaft receiver magnet (57) and the extension cartridge magnet (63), or plug (49), providing free rotation, without interference of any mechanical connection. No internal gears, ratchets, or other stop mechanisms are required, meaning no perceivable resistance is felt during rotation.

The opposing face magnets (SS) and extension cartridge face magnets (48) secure the brush head cartridge (123) from involuntarily rotation, however if using for long periods with the brush-head cartridge (123) in either its top or bottom orientation, the lock mechanism (62) can be used. The magnetic force can be easily overcome by pushing either the upper or lower finger rest areas (76) of the brush-head cartridge (123) the fingers to engage the rotational process.

The vertical application brush head cartridge (123) is intended to be used in its top orientation when painting downward, or when extra force is required to penetrate rough surfaces, and oriented in its bottom position when painting upward, or when applying a light finishing stroke to smooth out the paint, varnish, or other coating material.

FIGS. 17a-17f show a non-symmetrical handle (70) with its assemblies and components in multiple embodiments. A complete non-symmetrical handle (393) is comprised of a non-symmetrical handle (70), and a handle metacarpal handle strap assembly (165).

The non-symmetrical handle assembly (393) is made specifically for right-band or left-hand users. Multiple sizes can be produced to accommodate users of varying hand sizes. The non-symmetrical handle assembly (393) uses the same extension cartridges (41/126) available to the other handles of the inventive subject matter, as well as accessories which attached through an extension cartridge (41), or handle face shaft receiver channel (148).

Each region of the non-symmetrical handle (70) is formed to allow all parts of the user's hand to rest in neutral states, providing greater comfort, control, and reduced fatigue to the user. The addition of the metacarpal handle strap (165) allows the user to completely remove their fingers without possibility of dropping the brush regardless of the orientation of the hand. This also provides additional security as the user may use the fingers of the hand with the brush assembly (139) when on a ladder or other areas where a third point of contact is necessary.

FIGS. 17a-17d illustrate the various regions of the non-symmetrical handle (70) relative to the corresponding anatomy of the user. A rearward-facing convex surface on the lower back portion of the handle (143) is the palmar region of the handle, or palm rest area (143). a rearward facing convex surface on the upper front left portion of the handle (70) base is known as the finger rest area (145). On the right side of the handle base, a laterally protruding surface extends outwardly creating a shelf-like base, known as the thumb rest area (150), which extends rearward from the handle face (394), continually curving until it meets abuttingly with the palm rest area (143), which wraps around to meet abuttingly to form the finger rest area (149). The top of the handle has a hand rest area which is shown as a bottom-facing, convex surface disposed rearward of the upper finger rest area (149) and upper thumb rest area (150), is adapted to engage and rest against the dorsal saddle area (15) of a user's hand. The handle (70) narrows between the upper hand rest area (144) and lower thumb rest area (142), palm rest area (143), and finger rest area (145), and is adapted to engage the region of the user's hand between the forefinger (8) and thumb (9), known as the thenar webspace (13), when the holder is held.

With the aforementioned anatomical explanation in mind, the illustrative embodiments of the ergonomic hand tool disclosed herein may be thought of as configured to rest the bulk of the handle (70) against the dorsal saddle area (15) of the user's hand, when the user's hand is oriented with the dorsal saddle area (15) upward, with the body of other components of the hand tool adapted to receive the user's fingers and/or other hand areas to stabilize the handle in position. The metacarpal handle strap (165) additionally engages the metacarpal region (16) of the user's hand, as well as the extensor pollicis brevis tendon area (163), to additionally stabilize and receive the weight of the brush assembly (139).

The top of the handle houses a plug (140) which anchors the metacarpal strap to the handle (70). The metacarpal strap has a rearward-protruding aluminum bar (151) which bridges the handle plug (140) with the proximal metacarpal strap pad (158). Two additional aluminum bars (152, 153) extend laterally from the left and right side of the proximal pad (158). The right bar, the lateral thumb strap bar (152), terminates with a connection to the extensor pollicis brevis area pad (156). The left bar, the proximal lateral strap bar (153), terminates with a connection to the medial metacarpal pad (157). An additional aluminum bar, the distal lateral strap bar (154), protrudes from the medial metacarpal pad (157) to the distal metacarpal pad (159). Each bar has one or more adjustment slots (160), which allow the angle and position of each pad (156,157,158,159) to be customized to fit the user's hand. The position of the strap bars and pads are secured by screws (155) on top of the pads. Additionally, the strap bars (151, 152, 153, 154) can be bent to further form-fit the user's hand. The pads (156,157,158,159) are over-molded with a soft elastomer on their bottom side for comfort and a more secure fit for the user.

The handle (70) may be over-molded with a soft elastomer, ribbed or textured for an improved feel and grip. The metacarpal strap can be raised and lowered to connect or disconnect with the user's hand.

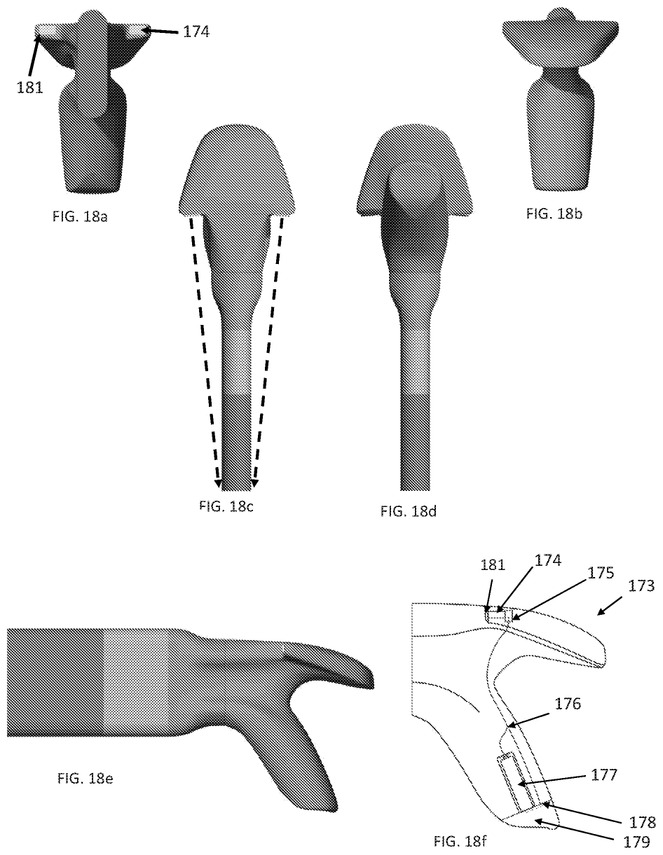

An additional embodiment of a handle (40) is shown in FIGS. 18a-18f, shows an LED-integrated handle (173), which contains internally-housed LED lights, which are disposed laterally from the area between the lateral perimeter of the top of the handle and the hand rest area (27). The LED lights (174) are forward-facing and angled to illuminate the work surface on both sides of the brush-head. The LED-Integrated handle (173) shares all other characteristics with the fixed-position handle (40). Any of the handles contemplated under the inventive subject matter could also incorporate the same LED-integrated handle top or other arrangements of LEDs.

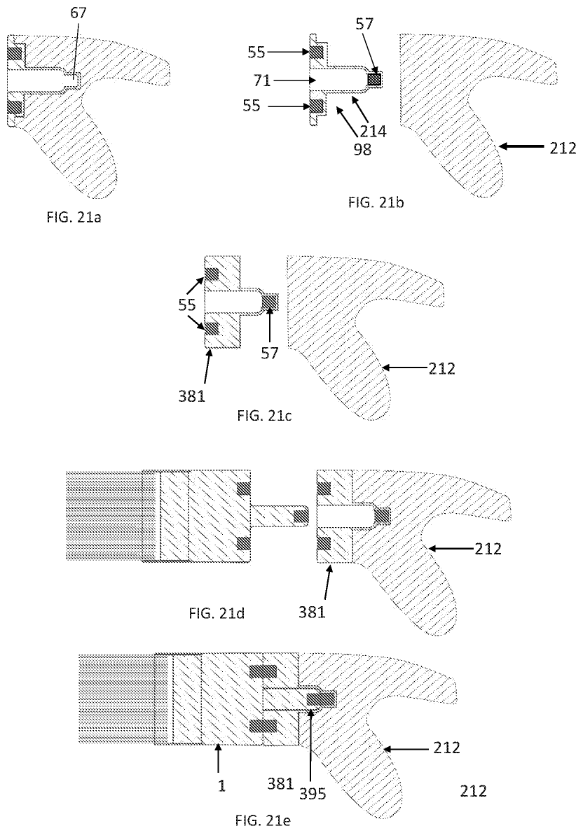

For users with larger hands, an extended length handle face body (381) shown in FIGS. 21a-21e can be made available. Any required length can feasibly be achieved to accommodate users of all hand sizes. The extended length handle face (381) connects to the handle (40) via screws (47) inserted proximally from within magnet bosses on both top and bottom. Face magnets (48) are glued and/or press fit into the magnet bosses, enclosing the screws. At the proximal end of the reward-facing shaft (395) is a magnet/steel plug boss (67) where a magnet (57) or steel plug (49) is glued and/or press fit. This creates a magnetic with the magnet of the handle face (35), without interference, securing it in place, but providing for resistant-free rotation of the extension cartridge. The brush insert cartridge (37) is inserted proximally into the extension cartridge (41) with its rearward-facing alignment shaft (50) mating to the transition shaft receiver (115) within the transition receiver channel (116) with the insert alignment ribs (121) of the brush insert cartridge (44) mating to the interior wall of the transition receiver channel (116). The brush insert cartridge. The brush insert cartridge (44) has a spherical deboss (51), which mates to a spherical embossed feature on the interior wall of the transition receiver channel (116), which holds the brush insert cartridge (44) in place. The combination of the brush insert cartridge (37) and extension cartridge (41) are called a 2-part brush-head cartridge (39).

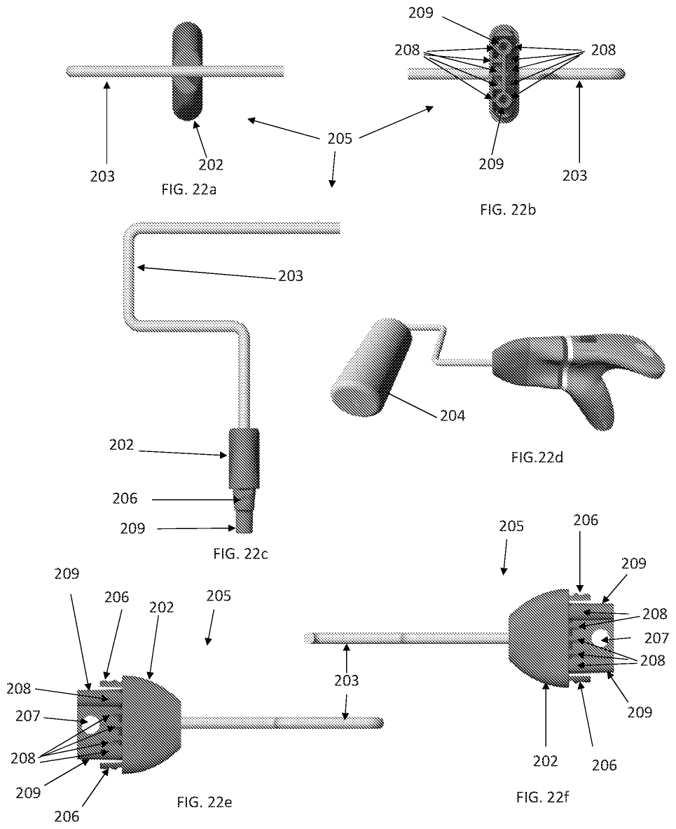

Rollers have become an essential tool for every painter. Smaller rollers are now often used for trim painting, furniture painting and other small painting projects. FIGS. 22a-22f illustrate a roller attachment (205) for the inventive subject matter. It is easy to assume the size of the roller may easily be made larger or smaller. FIG. 22d shows a roller attachment assembly (205) with a roller pad (204) on a handle (40).

The roller insert (202) is constructed of a hard plastic material. It is inserted proximally into the extension cartridge (41) with its rearward-facing alignment shaft (209) mating to the transition shaft receiver (115) within the transition receiver channel (116) with the insert alignment ribs (208) of the roller insert (202) mating to the interior wall of the transition receiver channel (116). The roller insert (202) has a spherical deboss (206), which mates to a spherical embossed feature on the interior wall of the transition receiver channel (116), which holds the roller attachment (205) in place. A roller rod (203), which protrudes distally from the insert, is over-molded in the insert. The roller rod (203) is formed with three 90-degree bends at varying lengths to form its final shape. A roller pad (204) is inserted onto the rod at its open end. The diameter of the rod is standard in the industry which allows the user to buy a roller pad (204) of their choice. Future embodiments include size and angle changes. Because a roller is generally not needed to be rotated, the lock feature (62) should be used with the roller attachment (205) in most circumstance. The roller insert (202) has a hang hole (207) which allows the roller to hang to dry, for storage, or for hanging on a retail hook/peg.

When painting a room with a typical 8-foot ceiling height, a person of average height is not able to reach the transition between the wall and ceiling. Subsequently, the person must use either a ladder, or stepladder, or other means to elevate themselves, to complete the edgework between the wall and ceiling. This presents several challenges and potential for injury. Falling off ladders is one of the leading causes of injury within the home. When painting the ceiling edge while on a ladder, to reduce the number of times the user must move the ladder, the user often stretches farther on the ladder to paint. By doing so, they not only produce greater strain on the shoulder, neck, back, arm, and hand, they also risk the latter tipping over. Because this issue is a common one, a telescoping extension (266) was created to allow a user of average height to be able to paint an 8-foot ceiling edge easily and efficiently, or other regions outside of their normal reach.

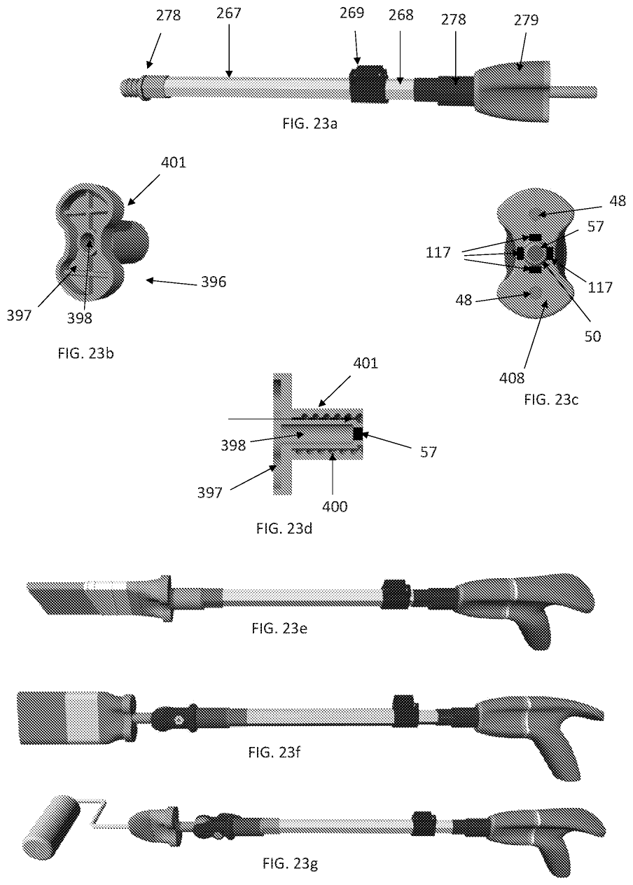

FIGS. 23a-23g show the assemblies and components of the telescoping extension (266) in detail. The assembly includes a male threaded extension cartridge (279), a female threaded tube receiver (278), an inner aluminum tube (268), a cam lever (269), an outer aluminum tube (267), and a male threaded tube shaft (278). It also includes a detachable female threaded extension cartridge receiver (396), which receives any extension cartridge (41).

The inner aluminum tube (268), a cam lever (269), and outer aluminum tube (267), make up the telescoping portion of the telescoping extension (266). This is a common configuration used largely for camera tripods. The cam lever (269) is disengaged allowing the outer tube (27) to extend, then the cam lever (269) is engaged to lock the tube's position.

The male threaded accessory extension cartridge (279) threads into the female threaded tube receiver (278), then is inserted into the handle (40). It can hold any extension cartridge (41) therefore it can receive any brush insert and the roller attachment (205).

Both the female threaded receiver (396) and pivoting ball socket (265) can be screwed onto the male threaded shaft (278), depending on the user's requirement.

The telescoping extension (266) can also accept a pivoting ball socket attachment (265).

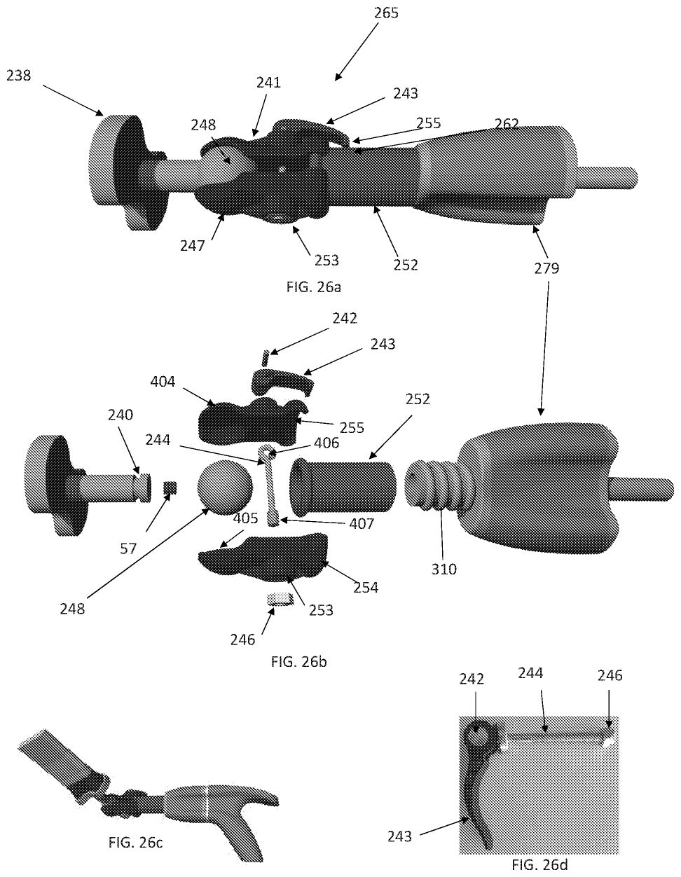

FIGS. 26a-26c show a male threaded extension cartridge (279). The male threaded extension cartridge face (408) has the same profile and the handle face (35). Both faces pull tangency from each other, creating a curve-continuous surface between the handle (40) and the male threaded extension cartridge (279). The thread pattern is known as a standard broom thread (310), which is a widely used thread system for many items which could be adaptable to the inventive subject matter. Because of the design of a paint brush, including the paint brush design of the inventive subject matter, much of the weight is located distally from the hand. Add to this, the weight of the paint at the end of the brush, it can put strain on the user's fingers, hand, wrist, arm, and shoulder when the arm is reaching and in repetitive motion for extended periods of time. To offset this distally oriented weight, a counterweight device can be adapted to different handle embodiments of the inventive subject matter, with the weight of the counterweight positioned on top of the handle (40), rearward of the hand rest area (27) thus assisting to offset the weight of the brush to mitigate the potential strain to the user's body.

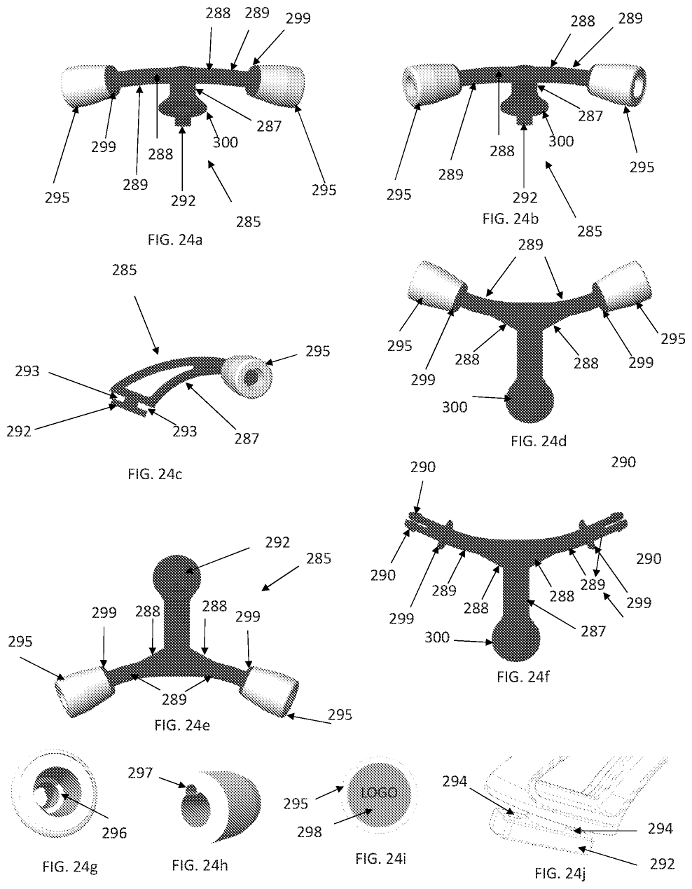

FIGS. 24a-24e show one counterweight (285) device embodiment, its components, and assemblies. The counterweight assembly (285) consists of a body (286), which has a riser shaft (287), right and left lateral crossbeams (289), gussets between the riser and cross beams (287), counterweight plugs (295), and a keylock mechanism (292), shown. The base also includes a counterweight plug stop feature (299), counterweight plug snap features (290), a counterweight plug alignment feature (291), and a receiving channel (293) to capture the handle top accessory port (83).

FIGS. 24f-24h show the counterweight plug (295), which is made of a heavy steel, or similar material. It has a lock edge (296), which is captured by the base plug snap features (290) when the counterweight plug (295) is inserted, and an alignment feature (297), which mates with the base alignment feature (291), ensuring the counterweight is oriented consistently.

FIG. 24h shows a logo badge (296) with an adhesive backing the covers the hole of the counterweight. The alignment features (297 and 291) allow for efficient, precise, and consistent orientation of the logo badge (296) on the counterweight plug (295) during production. To insert the counterweight (285) into the accessory port (83/411), the user holds the handle (40) with the front of the handle facing distally from the user, and the counterweight (285) above the handle with the counterweight keylock mechanism (292) over the handle accessory port (83) at a 90-degree angle relative to the handle (40), with the counterweight plugs (295) on the user's right side. The counterweight's keylock mechanism (292) is inserted fully into the pass-through (80) of the handle (40), then the counterweight is rotated 90 degrees clockwise, which will seat the spherical debosses (294) on the counterweight (285) with the spherical embosses (85) on the underside of the handle in the accessory port (83), securing the counterweight (285).

Falling off ladders is one of the most common injuries around the home. Allowing the user free use of both hands allows for three points of contact, which is necessary for safe operation of any ladder or scaffolding.

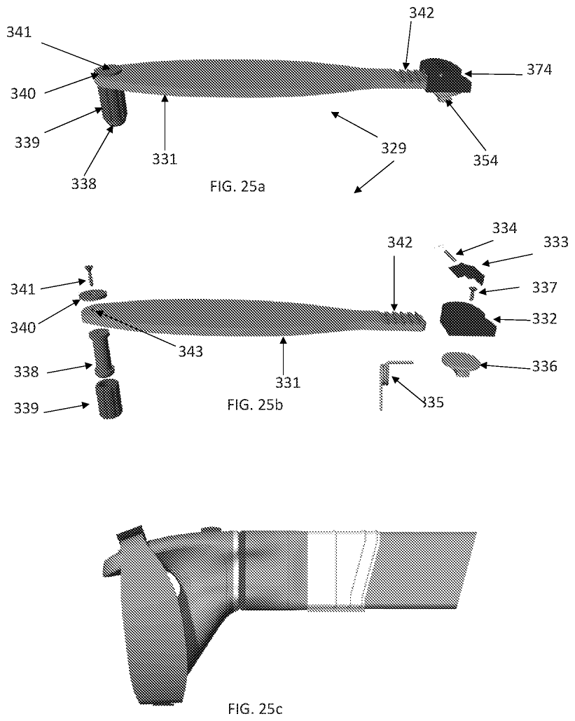

FIGS. 25a-25c show the assemblies and components of a ratcheting strap (329), which can be used with all handles of the inventive subject matter, with the exception of the non-symmetrical handle (70). The ratcheting apparatus shown is commonly used for straps, such as football helmets, motorcycles, and others, where quick adjustability and a secure hold are essential. The system and elements shown are examples of a ratcheting system. Other types of adjustable strap systems could also be applied.

The strap assembly (329) includes a ratchet-lock assembly (374), an elastomer strap (331), and a shaft assembly.

The shaft assembly includes, a shaft (338), an elastomer sleeve (339), a washer (340) and a fastener (341) such as a screw or rivet. The elastomer sleeve (338) slides onto the post, which is oriented on the underside of the strap (331) on the opposite side of the strap teeth (342). It is then secured to the strap (331) by inserting the fastener (341) through the washer (340), strap (331) then into the shaft where it is secured.

The ratchet-lock assembly (374) includes a main base (332), a ratchet lever (333), a dowel (334), or post, a torsion spring (335), a fastener (337) such as a screw or rivet, and a handle lock base (336). To assemble, the handle lock base (336) is attached to the underside of the ratchet base (332) with the lock feature (354) oriented away from the ratchet base (332), then secured with the fastener (337). The ratchet stop (333) is then inserted with the stop end (348) positioned on the same end of the base (332) as the spring leg pass-through (402), the spring leg (352) is inserted into the spring leg pass-through (402) from the inside, then the hole in the spring is aligned with the holes on the base and stop, the dowel is inserted through the base hole (344), spring hole (351), stop hole (346), then through the hole (344) on the opposite side of the base, completing the connection.

The rachet assembly (374) is attached first to the handle. To insert the rachet assembly (374) into the accessory port (83), the user holds the handle with the front of the handle facing distally from the user, and the rachet assembly (374) above the handle with the keylock mechanism (354) over the handle accessory port (83) at a 90-degree angle relative to the handle (40), The keylock mechanism (354) is inserted fully into the pass-through (80) of the handle (40), then the rachet assembly (374) is rotated 90 degrees clockwise, which will seat the spherical debosses (403) on the rachet assembly (374) with the spherical embosses (85) on the underside of the handle in the accessory port (83), securing the rachet assembly (374).

The shaft (338) is inserted into the handle plug accessory receiver channel (60), then the strap teeth (342) are fed into the ratchet base. The user then places their hand onto the handle (40) and the strap (331) can be adjusted to the tightness the user requires.

When painting around ceiling fans, behind toilets or pipes, or into a myriad of spaces where it is difficult, if not impossible to reach with the hand, a pivoting ball socket extension attachment, or ball socket system (265) can be a solution.

FIGS. 26a-26d show embodiments, assemblies, and components of the ball socket system (265) in detail. The socket system (265) includes a male threaded extension cartridge (279), a rotating female threaded receiver (252) a dual-walled ball socket chassis (241/247) with cam lever (264), and an extension cartridge receiver with over-molded elastomer ball (101).

The pivoting ball socket system (265) connects to any handle (40) with the shaft (50) of the male threaded extension cartridge (279), and can capture any extension cartridge (41) with any brush-head insert cartridge (37) or roller attachment (205)

To actuate and utilize the pivoting function, the user raises the cam lever handle (243) which releases the tension to the ball (248) and swivel receiver (252), yet still holding the assembly together with the left chassis (241) and right chassis (247). This allows the user to both rotate the extension cartridge receiver (101) and pivot it into the channel created in the two chassis, known as the left and right shaft cutaways (404/405). The chassis (241/247) are also free to rotate around the swivel receiver (252). Once the desired orientation as achieved, the user depresses the cam lever handle (243) and the unit (265) is secure.

The thread pattern on the swivel receiver is known as a standard broom thread (310), which is a universally used pattern for many tools. This is the thread pattern (310) used on all extension poles. The pivoting ball socket system (265) can be used with any extension pole on the market, adding additional utility, and use for painting in high places where a ladder is either not practicable, or available.

The inventive subject matter contemplates a handle that allows the user's fingers to be free from gripping in most instances, even so a user cannot release the fingers while the handle is pointed downward, or if needed to significantly grab, or hold something other than the handle. To further free the user's hand and secure the handle in any orientation without gripping with the fingers, several strap embodiments have been described. These straps allow the fingers on the hand of the handle to be used for when needed for support, stability, on a ladder for example, for convenience, or simply for resting the arm.

### Flex Strap

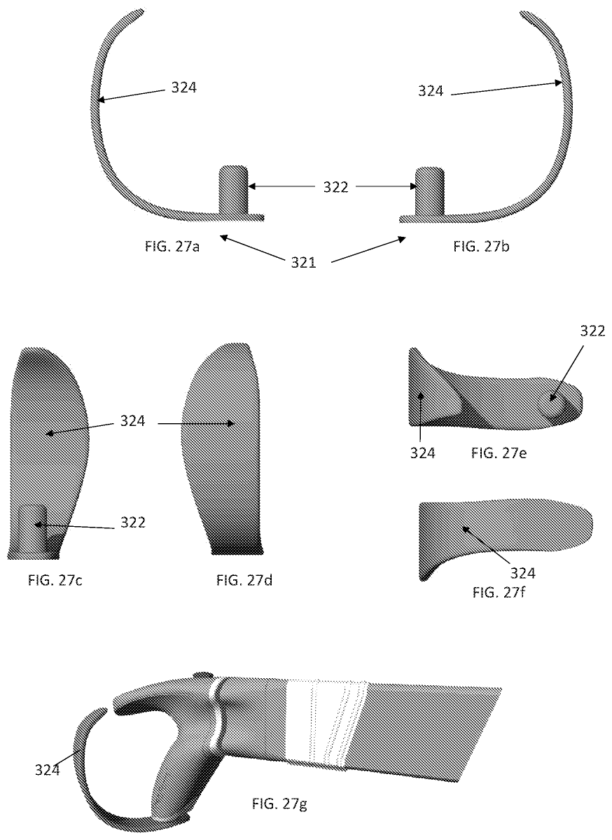

FIGS. 27a-27g some embodiments directed to a handle with a flexible fixed strap (321). The strap include supports configured with a shaft (322) that rises vertically from the lower body of the strap (324). The shaft may be made insertable into a handle plug accessory receiver (60) (40) on the bottom of the handle. The strap may have a continually contoured shape configured to receive the metacarpal region (16) on the back of a user's hand, allowing the user to use their fingers in situations where a third point of contact is necessary for safety or convenience. The support may be used for both right-handed and left-handed users. The support may be produced with a combination of hard plastics and soft elastomers, providing greater comfort and security for the user. The strap may be able to be adjusted closer or farther from the handle to accommodate very thick or very thin hands.

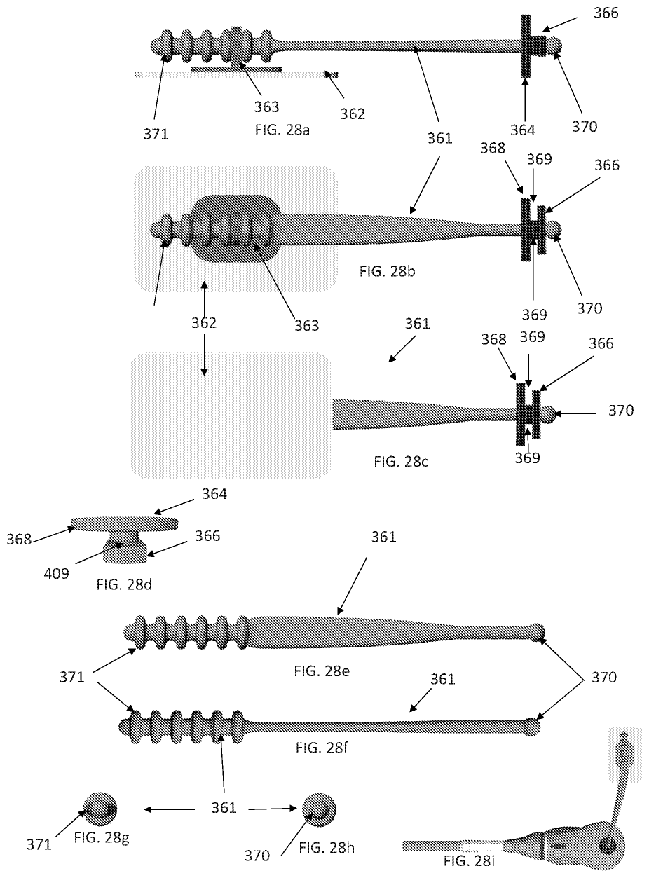

FIGS. 28a-28i show embodiments, assemblies, and components of a tethered silicone pad strap. This strap is not designed or intended to secure the handle (40) tightly to the hand, rather to allow the user to release the hand and utilize the fingers on the hand with the handle (40) for support on a ladder, to carry the paint pail, or for other reasons, providing ease of use. Silicone, in many forms has no adverse effect on the body. Silicone is widely used in the medical field and similar pads are used in electric muscle stimulators. They can be attached removed and attached again repeatedly. The pad is place in the metacarpal region (16) on the back of the hand.

FIGS. 28a-28c show the assembly, which consists of a handle lock base (364), strap tether, or tether (361), a plastic metacarpal base (363) and a silicone pad (362). The tether has multiple ribs that can pass through and eyelet (367) on the metacarpal base (363), allowing adjustment in placement of the pad.

To insert the tethered silicone pad strap (360) into the accessory port (83), the user holds the handle in one hand, and the tethered silicone pad strap (360) in the other, above the handle with the keylock mechanism (366) over the handle accessory port (83) at a 90-degree angle relative to the handle (40), when the keylock mechanism (366) is inserted fully into the pass-through (80) of the handle (40), then the keylock mechanism (366) is rotated 90 degrees clockwise, which will seat the spherical debosses (403) on the tethered silicone pad strap (360) with the spherical embosses (85) on the underside of the handle in the accessory port (83), securing the tethered silicone pad strap (360). Because of the design of a paint brush, including the paint brush design of the inventive subject matter, much of the weight is located distally from the hand. Add to this, the weight of the paint at the end of the brush, it can put strain on the user's fingers, hand, wrist, arm, and shoulder when the arm is reaching and in repetitive motion for extended periods of time. To offset this distally oriented weight, a counterweight device (285/303) can be adapted to different handle embodiments of the inventive subject matter, with the weight of the counterweight (285/303) positioned on top of the handle (40), rearward of the hand rest area (27) thus assisting to offset the weight of the brush to mitigate the potential strain to the user's body. Additionally, the surface or area being painted may not have adequate light to see variations in coverage thickness or offer the ability to define edges or the surface clearly. Lights are available that secure to a conventional paintbrush (325); however, these lights are place distally from the hand, adding additional weight to an already unbalance tool. Also, they interfere with visibility to the work surface, often causing the user frustration. To combine the inadequacy of lack of counterbalance and light, a combination counterweight light can solve both issues in a practical manner.

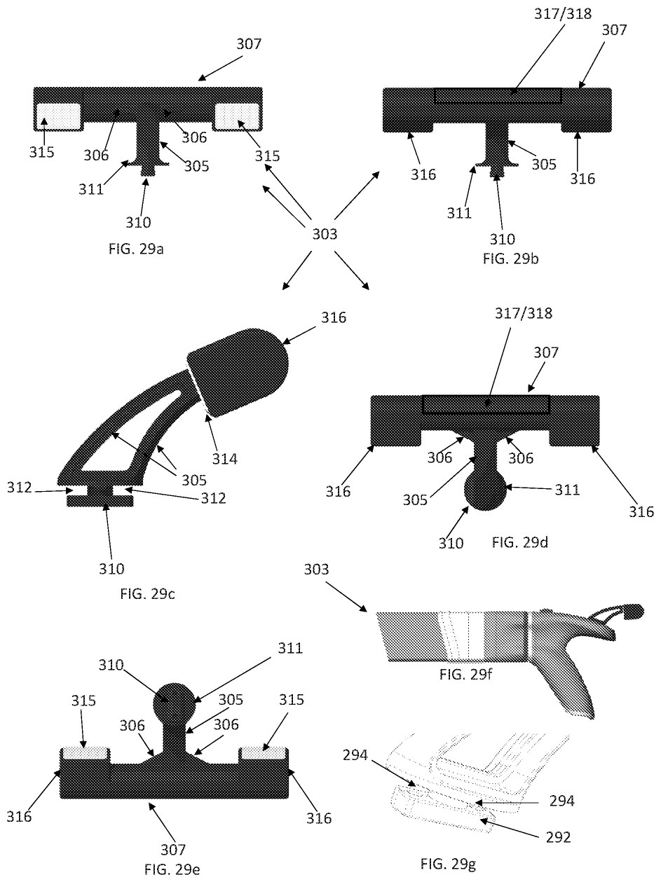

FIGS. 29a-29f show the assemblies and components of an LED-integrated light and/or counterweight system (303). The LED counterweight chassis, or LED chassis (304), can be made of steel, or similar heavy material, creating a counterweight effect for the forward-weighted brush (36). Conversely, the chassis can be made of lightweight plastic for those wishing to not have the additional weight

The LED lights (315) are positioned within housings on the lateral edges of the front-facing side of the crossbeams (307), which extend laterally from the riser shaft (305), which extends distally and rearward from the shaft base (311) when viewed as the LED counterweight assembly (303) is attached to the handle (40). The lights are directly to the vertical midsection of an assumed distal end of the bristles of an average brush-head cartridge (41), providing light to the entire workable surface. The lights are positioned above the user's hand and wider than the handle top profile to eliminate the possibility of interference with the light projected from the LEDs.

A battery compartment (317) is located in the cross-beam (307) as well as the electronics. The battery (319) acts as an additional counterweight.

To insert the LED counterweight (303) into the accessory port (83/411), the user holds the handle with the front of the handle facing distally from the user, and the counterweight (285) above the handle with the LED counterweight keylock mechanism (292) over the handle accessory port (83) at a 90-degree angle relative to the handle (40), with the counterweight plugs (295) on the user's right side. When the LED counterweight keylock mechanism (292) is inserted fully into the pass-through (80) of the handle (40), then the counterweight is rotated 90 degrees clockwise, which will seat the spherical debosses (294) on the LED counterweight (303) with the spherical embosses (85) on the underside of the handle in the accessory port (83), securing the LED counterweight (303).

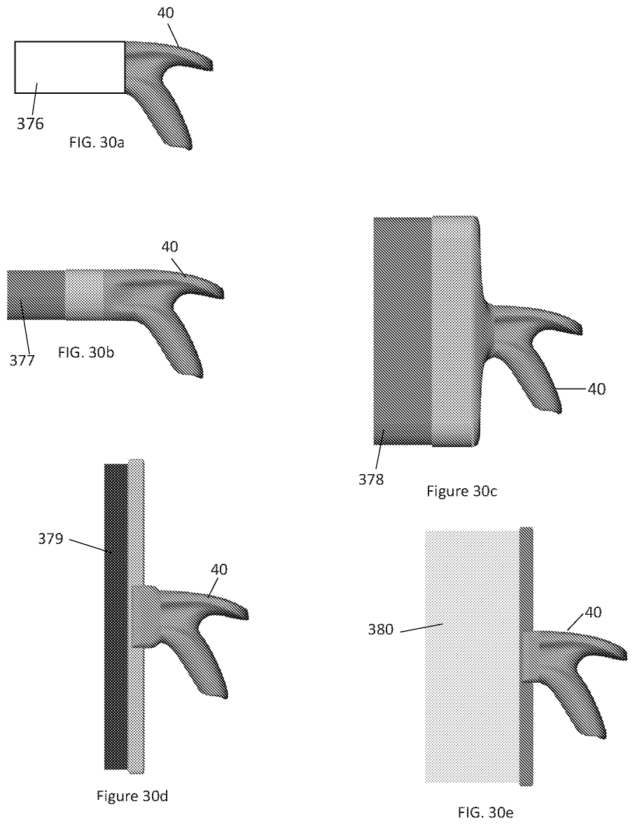

FIGS. 30a-30e show the handle (40) adapted to several possible attachment possibilities. FIG. 30a shows a handle (40) of the inventive subject matter with a generic schematic of a tool-head, or other attachable feature 376. Possible tool attachments, include, but are not limited to, a drywall blade/knife, window washer brush, window washer squeegee, garden shovel, garden weed puller, adaptable kitchen utensils for individuals with physical handicaps, garden utensils for individuals with physical handicaps, scrappers, sanding pads, mobile phone holder as gimbal for shooting video, and so on.

FIG. 30b shows an elevation view of a handle (40) creating a 2-part brush (377), FIG. 30c shows a right elevation view of a handle (40) with a window washer brush 378, FIG. 30d shows a right elevation view of a handle (40) with a window washer squeegee 379. FIG. 30e shows a right elevation view of a handle (40) with a drywall knife, or drywall blade 380. These are meant to represent just a small sample of possible embodiments and the attachments, with are adaptable to all handle variations (40, 58, 68, 69, 70).

In this description, orientational and directional terms such as “left,” “right,” “front,” “rear,” “forward,” “rearward,” “top,” “bottom,” and so forth are used for clarity of illustration and generally refer to the relative positions of components and other objects illustrated in the drawings but are not intended to be limiting, as the ergonomic tools shown are not restricted to the orientations and positions shown in the drawings. For directional terms related to the inventive subject matter we use a front elevation view in which the right hand of a person facing forward would be on the left side of the front elevation view.

Persons skilled in the art will recognize that many modifications and variations are possible in the details, materials, and arrangements of the parts and actions which have been described and illustrated in order to explain the nature of the inventive subject matter, and that such modifications and variations do not depart from the spirit and scope of the teachings and claims contained therein. All patent and non-patent literature cited herein is hereby incorporated by references in its entirety for all purposes.

As used herein, “and/or” means “and” or “or”, as well as “and” and “or”. moreover, any and all patent and non-patent literature cited herein is hereby incorporated by references in its entirety for all purposes.

The principles described above in connection with any particular example can be combined with the principles described in connection with any one or more of the other examples. Accordingly, this detailed description shall not be construed in a limiting sense, and following a review of this disclosure, those of ordinary skill in the art will appreciate the wide variety of systems that can be devised using the various concepts described herein. Moreover, those of ordinary skill in the art will appreciate that the exemplary embodiments disclosed herein can be adapted to various configurations without departing from the disclosed principles.

The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein but are to be accorded the full scope consistent with the language of the claims, where in reference to an element in the singular, such as by use of the article “a” or “an” is no intended to mean “one and only one” unless specifically stated so, but rather “one or more”.

All structural and functional equivalents to the elements of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed as “a means plus function” claim under US patent law, unless the element is expressly recited using the phrase “means for” or “step for”.

1-40. (canceled)

41. A handle for use with a complementary cartridge for supporting a tool, the handle comprising:
a downwardly, vertically extending proximal handle portion for receiving at least one of a palmar saddle and a thenar webspace of a user's hand, and extending therefrom a horizontally extending distal handle portion configured for receiving the cartridge,
the distal handle portion comprising a face, wherein the face comprises a recess configured for receiving a shaft of the cartridge, wherein the shaft and the recess are alignable along a longitudinal axis of the distal handle portion, the recess being configured so that the shaft is rotatable in the recess,
the face further comprising one or more engagement elements configured to engage with complementary engagement elements on an opposing surface of the cartridge, enabling the cartridge to be rotated around the axis from a first rotational position to a second rotational position, the complementary engagement elements configured to lockably engage in a plurality of rotational positions to fix a rotational position of the cartridge relative to the handle,
wherein the handle is configured such that the handle being gripped in the user's hand with the palmar saddle of the user's hand positioned in contact with the palmar saddle rest area corresponds to the face of the handle being positioned proximate to the user's proximal interphalangeal joint.

42. The handle of claim 41, further comprising two or more contoured areas comprising, on opposing lateral sides of a body of the handle, a pair of upper and lower ridges flaring from the body and extending longitudinally along each of the opposing lateral sides of the body, wherein each pair of ridges defines respective finger and thumb rest areas, wherein each pair of ridges is configured to abuttingly engage a respective finger or thumb of the user's hand placed in the respective finger or thumb rest area during use.

43. The handle of claim 41, further comprising one or more contoured areas comprising a hand rest area having a bottom-facing surface disposed on a body of the handle, above finger and thumb rest areas of the body and above a handgrip of the handle, the bottom-facing surface extending longitudinally and rearwardly from the body beyond the finger and thumb rest areas, the bottom surface extending laterally wider than the body, thereby being configured to rest on a dorsal saddle area of the user's hand.

44. The handle of claim 43, further comprising:
an accessory port, disposed on a rearward section of the hand rest area and the bottom-facing surface, and below the palmar saddle rest area; and
a strap, wherein the strap is connected to the accessory port.

45. The handle of claim 41, further comprising the complementary cartridge for supporting a tool, the handle and complementary cartridge thereby forming a handle and cartridge assembly, wherein the complementary cartridge comprises a distal working end that comprises a hand tool or is configured to support a removable hand tool.

46. The handle and cartridge assembly of claim 45, wherein the handle and the cartridge have mirrored surface edges, which are mirrored both vertically and horizontally, by planes crossing at the center of the recess of the handle and the shaft of the cartridge, enabling a blended curve-continuous surface at a juncture of the handle and the cartridge.

47. The handle and cartridge assembly of claim 45, wherein the blended curve-continuous surface at a juncture of the handle and the cartridge forms longitudinal finger and thumb rest areas that extend along both the handle and the cartridge.

48. The handle and cartridge assembly of claim 45, wherein the cartridge comprises one or more contoured areas on opposing lateral sides of a body of the cartridge, a pair of upper and lower ridges flaring from the body and extending longitudinally along each of the opposing sides of the body, wherein the pairs of ridges define respective finger and thumb rest areas, wherein the finger and thumb rest areas are configured to abuttingly engage the one or more respective fingers and thumb placed respectively in the finger and thumb rest areas.

49. The handle of claim 41, further wherein the face of the proximal handle portion has the recess disposed in a central section of the face, and the one or more engagement elements disposed proximate to the recess.

50. The handle of claim 41, wherein the one or more engagement elements are configured to enable the cartridge to be rotated around the axis by at least 90 degrees from the first rotational position to the second rotational position.

51. The handle of claim 41, wherein the handle is configured with a forward-facing surface end that ends at a juncture slightly rearward of the intended location areas for a first knuckle of the forefinger of the user.

52. The handle of claim 41, further comprising a light, positioned on the handle, wherein the light is positioned rearward of a top of one or more hand rest areas on one or more sides of a body of the handle, wherein the light faces forward and is configured to emit light towards one or more lateral opposing edges of a tool positionable at a distal end of the distal handle portion.

53. The handle of claim 41, further comprising an integrated internal lock mechanism.

54. The handle of claim 53, wherein the integrated internal lock mechanism comprises a shaft, and
wherein the handle comprises a pass-through to receive the shaft of the integrated lock mechanism, and
wherein the integrated internal lock mechanism comprises a cantilever spring push button mechanism for operating the integrated lock mechanism.

55. The handle of claim 41, wherein the handle has halves which are mirrored equivalently enabling right-hand or left-hand use.

56. The handle of claim 41, wherein the handle has halves which are asymmetrical enabling the user's hand to rest in natural and neutral states specific to either right-hand or left-hand use.

57. The handle of claim 41, wherein the front face of the handle is forwardly extendable by use of an elongatable connection.

58. The handle of claim 41, wherein the handle comprises a lower proximal section and an upper distal section, which are at least partially spaced apart from each other by an intermediate section having a greater degree of flexibility than the proximal section.

59. The handle of claim 41, wherein the lower proximal section and the upper distal section are connected by a connecting strut that is bendable within a vertical plane of the handle.

60. The handle of claim 41, further comprising:
one or more outer surface areas that comprise an elastomer;
a handle palm rest area that comprises texturing for additional grip, and
wherein the handle is configured to articulate in order to adjust one or more of a distance and an angle between a hand rest area of the handle and the palmar saddle rest area.
